(19) United States
(12) Patent Application Publication
(10) Pub. No.: US 2002/0077867 A1
(43) Pub. Date: Jun. 20, 2002

(54) Automated claims fulfillment system

(76) Inventors: Richard Simon Gittins, London (GB); Peter Edward Richardson, Clovenfords (GB); John Charles Harvie, Storrington (GB)

Correspondence Address: STAAS & HALSEY LLP, 700 11TH STREET, NW, SUITE 500, WASHINGTON, DC, 20001, US

(21) Appl. No.: 09/789,730

(22) Filed: Feb. 22, 2001

Related U.S. Application Data
(60) Provisional application No. 60/255,076, filed on Dec. 14, 2000.

(51) Int. Cl. G06F 17/60

(52) U.S. Cl. 705/4

(57) ABSTRACT

A software-implemented, automated claims fulfillment system for fulfilling insurance claims. The claims fulfillment system aggregates claims fulfillment volume from multiple insurers for future periods, and reverse auctions the aggregated claims fulfillment volume to suppliers.

### BACKGROUND OF THE INVENTION

1. Field of the Invention

The present invention relates to an automated claims fulfillment system which automatically coordinates activities between a claimant, an insurer and suppliers, to fulfill an insurance claim.

2. Description of the Related Art

In the insurance industry, when a claimant submits a claim to an insurer for loss of an insured item, the claim must typically be settled in accordance with a conventional claims settlement process. Generally, a conventional claims settlement process includes a “claims agreement” phase during which the insurer makes a decision to settle the claim, and then a “fulfillment” phase during which the insurer takes steps to indemnify the claimant.

A conventional fulfillment phase is highly ineffective and inefficient due to a number of key factors.

For example, with a conventional fulfillment phase, claims are often settled in cash (at an equivalent retail value) rather than indemnifying by providing replacement goods. This has the potential to increase fraud (that is, the claimant inventing entirely invalid claims) and claims leakage (that is, the claimant inflating the value of valid claims).

Sometimes, replacement goods are provided instead of cash. In such cases, the insurer often relinquishes control to the claimant over the sourcing of the replacement goods, thereby increasing the potential for fraud and claims leakage.

Moreover, many insurers often have decentralized areas of operations (for example, regional claims centers, branch offices, etc). As a result, with a conventional fulfillment phase, “on-contract” procurement (that is, procurement for products that exist in a supplier catalog or from a supplier with whom contract or discounted rates have been agreed) is not maximized. Consequently, procurement leverage available to buyers over suppliers is relatively low, and the ability to disintermediate and reshape existing supply chains is limited.

In addition, with a conventional fulfillment phase, claimant satisfaction is often low because confusion over market values causes claimants to perceive that insurers “don't pay up in full.” Also, claimant satisfaction is often low because claimants are expected to complete the fulfillment phase themselves, and because the fulfillment phase takes too long.

Further, with a conventional fulfillment phase, claims processing costs are increased as a consequence of delay.

Moreover, with a conventional fulfillment phase, supplier performance can be relatively poor because there is little or no after sales feedback on supplier performance, and because suppliers are not effectively integrated into the process.

Further, with a conventional fulfillment phase, procurement processing is manual. As a result, procurement processing costs are increased for both buyers and suppliers, and management information required to benchmark and improve processes or procurement leverage is not available.

Also, with a conventional fulfillment phase, insurers are not often able to use a claim as a springboard for selling other products and services because there is little or no “after fulfillment” follow-up service.

Moreover, with conventional fulfillment of insurance claims, insurers typically negotiate deals with either single suppliers, or multiple supplier consolidators, to control costs. These deals have squeezed the profits of the suppliers, with whom the insurers will insist give a discount if they want any business at all. At the same time the insurers are demanding a higher quality of product or service which requires substantial investment by the suppliers in new equipment and/or personnel. As an example, after an investment by an auto repair shop (e.g., a supplier for an auto repair claim) which reduces a three hour process to a one hour process, the insurers' response would typically be to pay the repair shop for just one hour of labor. It is clear that if insurers want to continue to drive discounts in this area they cannot just keep squeezing the repairs for a reduction in cost.

### SUMMARY OF THE INVENTION

Accordingly, it is an object of the present invention to automate the fulfillment phase of a claims settlement process, to thereby improve effectiveness and efficiency of the fulfillment phase.

More specifically, it is an object of the present invention, in the fulfillment phase of a claims settlement process, to reduce claims leakage, reduce fraud, reduce procurement costs, increase leverage of buyers over suppliers, improve the ability to disintermediate and reshape existing supply chains, improve supplier performance, improve claimant satisfaction and use a claim as a springboard for selling other products and services.

Additional objects and advantages of the invention will be set forth in part in the description which follows, and, in part, will be obvious from the description, or may be learned by practice of the invention.

Objects of the present invention are achieved by providing a process including (a) aggregating claims fulfillment volume from multiple insurers for future periods; and (b) reverse auctioning the aggregated claims fulfillment volume to suppliers.

Objects of the present invention are also achieved by providing an apparatus including (a) an automated claims fulfillment system, and (b) computer communication channels connecting a plurality of insurers and a plurality of suppliers to the automated claims fulfillment system. The automated claims fulfillment system receives an indication of claims fulfillment volume for future periods from the insurers through the computer communication channels, aggregates the claims fulfillment volume indicated by the insurers and auctions the aggregated claims fulfillment volume to the suppliers through the computer communication channels.

Moreover, objects of the present invention are achieved by providing a computer-implemented process including (a) automatically, by computer processing, aggregating claims fulfillment volume from multiple insurers for future periods, and (b) automatically, by computer processing, auctioning the aggregated claims fulfillment volume to suppliers.

In addition, objects of the present invention are achieved by providing a process including (a) aggregating claims fulfillment volume from a plurality of insurers, (b) estimating total claims fulfillment volume of the aggregated claims fulfillment volume to be guaranteed to suppliers, (c) auctioning the estimated total claims fulfillment volume to the suppliers, and (d) providing guarantees of the auctioned claims fulfillment volume to suppliers winning the reverse auctioned claims fulfillment volume.

Objects of the present invention are further achieved by providing a process including (a) committing claims fulfillment volume for future periods by a plurality of insurers, (b) aggregating the committed claims fulfillment volume from the plurality of insurers, (c) estimating total claims fulfillment volume of the aggregated, committed claims fulfillment volume to be guaranteed to suppliers, (d) auctioning the estimated total claims fulfillment volume to the suppliers, and (e) providing guarantees of the auctioned claims fulfillment volume to suppliers winning the reverse auctioned claims fulfillment volume.

Objects of the present invention are also achieved by providing a process including (a) committing claims fulfillment volume for future periods by a plurality of insurers, (b) aggregating the committed claims fulfillment volume from the plurality of insurers, (c) estimating total claims fulfillment volume of the aggregated, committed claims fulfillment volume to be guaranteed to suppliers in accordance with econometric and risk adjusted return models, (d) auctioning the estimated total claims fulfillment volume to the suppliers, (e) providing guarantees of the auctioned claims fulfillment volume to suppliers winning the auctioned claims fulfillment volume, (f) presenting the winning suppliers to claimants submitting actual claims, (g) selecting presented suppliers by the claimants to fulfill the claims, and (h) load balancing actual claims fulfillment volume directed to the winning suppliers.

Objects of the present invention are also achieved by providing a computer-implemented process including (a) committing claims fulfillment volume for future periods by a plurality of insurers, (b) automatically, by a computer, aggregating the committed claims fulfillment volume from the plurality of insurers, (c) automatically, by a computer, estimating total claims fulfillment volume of the aggregated, committed claims fulfillment volume to be guaranteed to suppliers, (d) auctioning, by a computer, the estimated total claims fulfillment volume to the suppliers, and (e) providing guarantees of the auctioned claims fulfillment volume to suppliers winning the auctioned claims fulfillment volume.

Further, objects of the present invention are achieved by providing a computerimplemented process including (a) committing claims fulfillment volume for future periods by a plurality of insurers, (b) aggregating, by a computer, the committed claims fulfillment volume from the plurality of insurers, (c) estimating, by a computer, total claims fulfillment volume of the aggregated, committed claims fulfillment volume to be guaranteed to suppliers in accordance with econometric and risk adjusted return models, (d) auctioning, by a computer, the estimated total claims fulfillment volume to the suppliers, (e) providing guarantees of the auctioned claims fulfillment volume to suppliers winning the auctioned claims fulfillment volume, and (f) load balancing, by a computer, actual claims fulfillment volume directed to the winning suppliers.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a diagram illustrating a claims fulfillment system, according to an embodiment of the present invention.

FIGS. 2 and 3 are flowcharts illustrating the overall operation of a claims fulfillment system, according to an embodiment of the present invention.

FIG. 4 is a diagram illustrating a claims fulfillment system, according to an additional embodiment of the present invention.

FIG. 5 is a diagram illustrating an example of an overall architecture for implementing a claims fulfillment system, according to an embodiment of the present invention.

FIG. 6 is a flow chart illustrating the overall operation of a claims fulfillment system, according to an additional embodiment of the present invention.

FIGS. 7 to 12 are diagrams illustrating example screen displays of a claims fulfillment system, according to an embodiment of the present invention.

FIG. 13 is a diagram illustrating a claims fulfillment system, according to an additional embodiment of the present invention.

FIG. 14 is a diagram illustrating a possible architecture of claims fulfillment system for integrating insurers and suppliers, according to an embodiment of the present invention.

### DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

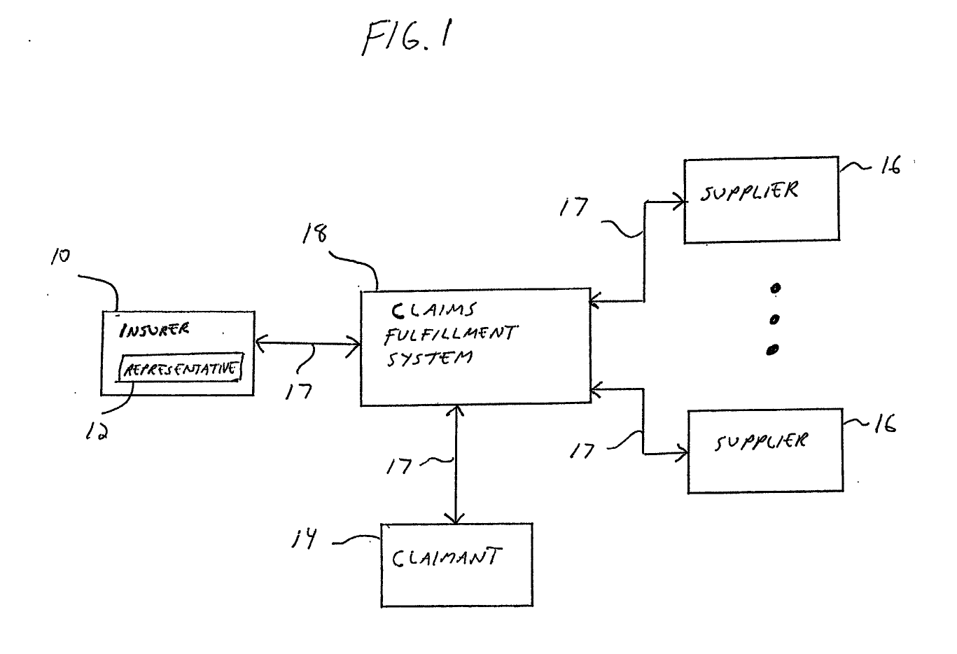

FIG. 1 is a diagram illustrating a claims fulfillment system, according to an embodiment of the present invention. Referring now to FIG. 1, an insurer 10 offers insurance. A representative 12 acts on behalf of an insurer 10 and would typically be an employee of insurer 10 or a contractor working on behalf of insurer 10. A claimant 14 has insurance with insurer 10, and submits a claim for loss of an insured item. To fulfill the insurance claim, a plurality of suppliers 16 are available to replace, re-manufacture or repair the insured item in fulfillment of the claim.

Communication channels 17 connect insurer 10, claimant 14 and suppliers 16 to claims fulfillment system 18. Communication channels 17 might comprise public and/or private networks, the Internet, local area networks (LANs), wide area networks (WANs), optical communication networks, wireless communication networks, other types of electronic networks, etc. Such communication channels would typically allow computer communications therethrough, and can therefore be referred to as a computer communications channel. Moreover, different types of communication channels 17 can be used to connect insurer 10, claimant 14 and/or suppliers 16 to claims fulfillment system 18. For example, a respective communication channel 17 connecting insurer 10 to claims fulfillment system 18 might be a different type than the respective communication channel 17 connecting claimant 14 to claims fulfillment system 18. Moreover, different suppliers 16 may be connected to claims fulfillment system 18 via different types of communication channels 17. In some embodiments, the same communication channel 17 might be used to connect insurer 10, claimant 14 and/or suppliers 16 to claims fulfillment system 18.

Claims fulfillment system 18 automatically coordinates activities between insurer 10 (typically through representative 12), claimant 14 and suppliers 16 so that claimant 14 is provided with a claimant-selected product or service by at least one of suppliers 16.

In a typical embodiment, claims fulfillment system 18 would typically have the ability to manage various types of products and/or services. For example, claims fulfillment system 18 preferably has the ability to manage on-catalog and non-catalog products, bespoke products/services, and specialized services.

On-catalog and non-catalog products are products which are held on a catalog against a contract with suppliers 16, or that have a similar replacement to those held on the catalog. If the insured product is this type of product, the insured product would typically be replaced in fulfillment of the claim.

Bespoke products/services are products/services that are made specifically for a claimant or products that are made in limited numbers. If the insured item is this type of product, the insured product will typically have to be replaced by re-manufacture or replacement with an item that is similar.

Specialized services refers to repair/rebuild services required to essentially “fix” the insured item. Such specialized services are sometimes required to fulfill a claim.

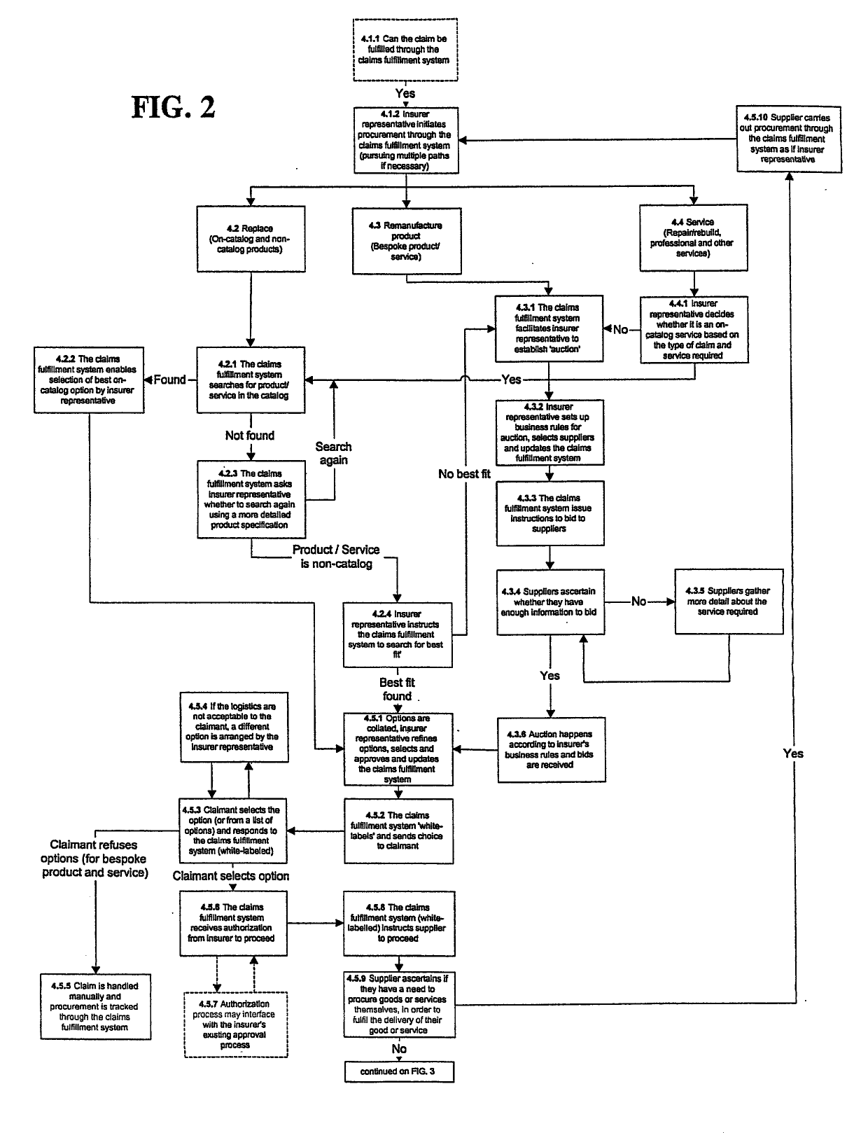

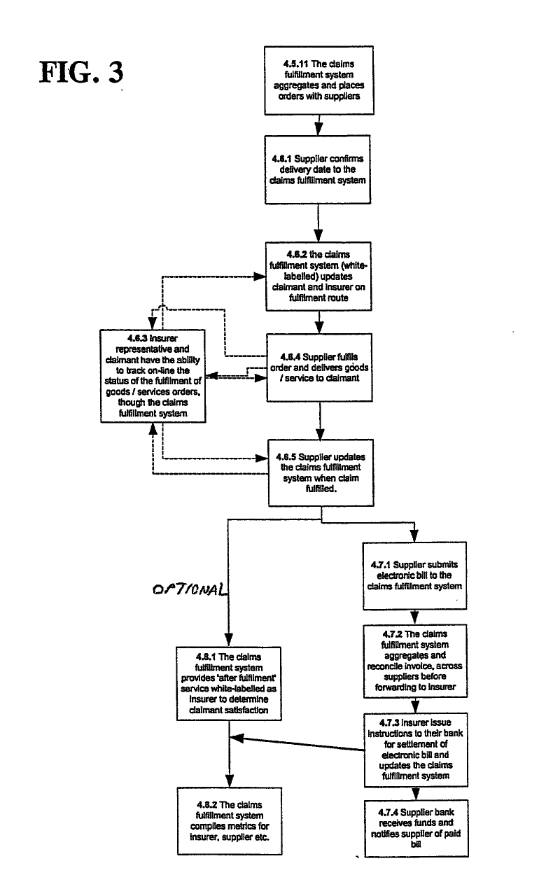

FIGS. 2 and 3 are flowcharts illustrating the operation of claims fulfillment system 18. Referring now to FIGS. 2 and 3, the following is a description of each step:

Step 4.1.1: Can the claim be fulfilled through claims fulfillment system 18 ?

Input: Details of the claim are received from insurer 10 (potentially manually or automatically).

Activity: Determine whether the procurement required to meet a claim can be processed through claims fulfillment system 18.

Output: N/A.

Owner: Representative 12.

Next Step: 4.1.2.

Step 4.1.2: Representative 12 initiates procurement through claims fulfillment system 18 (pursuing multiple paths if necessary).

Prior Step: 4.1.1.

Input: A description of the goods damaged or stolen and/or services required to fulfill the claim.

Activity: Send a description of the required goods or services (typically including service level agreements) to claims fulfillment system 18 and typically pursue multiple procurement methods if necessary.

Output: N/A.

Owner: Representative 12.

Next Step: 4.2 (Replace), 4.3 (Remanufacture), 4.4 (Service).

Step 4.2 Replace (On-catalog and non-catalog products).

Step 4.2.1. Claims fulfillment system 18 searches for the product/service in the catalog.

Prior Step: 4.2 (Replace), 4.4.1 (On-catalog service).

Input: Product/service description from representative 12 (and, typically, service level, stock availability requirements if necessary).

Activity: Claims fulfillment system 18 searches supplier catalog to match the description of the product/service.

Output: N/A.

Owner: Claims fulfillment system 18.

Next Step: 4.2.2 (Found), 4.2.3 (Not found).

Step 4.2.2 Claims fulfillment system 18 enables selection of best on-catalog option by representative.

Prior Step: 4.2.1 (Search).

Input: A list of options for replacement products/services, typically including associated pricing, service levels and stock availability as retrieved by search.

Activity: Representative 12 selects the best solution to meet the needs, typically based on a combination of price, availability, service level etc.

Output: The best source for the replacement of that product according to required service level.

Owner: Representative 12.

Next Step: 4.5.1 (Collate options).

Step 4.2.3 Claims fulfillment system 18 asks representative 12 whether to search again using a more detailed product specification.

Prior Step: 4.2.1 (Search).

Input: Product/service can not be found in the catalog.

Activity: Claims fulfillment system 18 asks representative 12 whether to search again and if so requests a more specific product description (typically via preferred technology).

Output: Typically, e-mail, web-page, WAP phone, SMS message etc. to representative 12 (and returned to claims fulfillment system 18) containing more specific product detail and whether to search again.

Owner: Claims fulfillment system 18.

Next Step: 4.2.1 (Search again), 4.2.4 (Product/service not on catalog).

Step 4.2.4 Representative 12 instructs claims fulfillment system 18 to search for best fit.

Prior Step: 4.2.3 (More detail).

Input: Search string for replacement product/service (enabled by “advanced” search).

Activity: Representative 12 instructs claims fulfillment system 18 to search for similar options to that of the product/service required.

Output: A list of best fit options.

Owner: Representative 12.

Next Step: 4.5.1 (best fit found), 4.3.1 (no best fit).

Step 4.3 Remanufacture product (bespoke product/service).

Step 4.3.1: Claims fulfillment system 18 facilitates representative 12 to establish “auction.”

Prior Step: 4.3 (Remanufacture), 4.4.1 (Non-catalog service), 4.2.4 (product/service not on catalog).

Input: Details of the bespoke product or service are entered into claims fulfillment system 18. Preferably, claims fulfillment system 18 allows drawings, photographic images etc, to be entered.

Activity: Details of product or service to be acquired are stored.

Output: N/A.

Owner: Representative 12.

Next Step: 4.3.2 (Set up rules).

Step 4.3.2 Representative 12 sets up business rules for auction, and would typically select suppliers 16 and update claims fulfillment system 18.

Prior Step: 4.3.1 (Establish auction).

Input: Details of the bespoke product or service are entered into the claims fulfillment system 18. Preferably, claims fulfillment system 18 allows drawings, photographic images etc., to be entered.

Activity: Representative 12 sets up an auction and establishes business rules (e.g. closed auction, open auction), and, typically, also establishes duration, etc. Typically, representative 12 would also select suppliers 16 to be involved in the auction from, for example, an insurer's panel (based, for example, on ability, past performance, geography).

Output: A set of suppliers 16 to be involved in the auction and all information necessary to begin the auction.

Owner: Representative 12.

Next Step: 4.3.3 (issue instructions to bid).

Step 4.3.3 Claims fulfillment system 18 issues instructions to bid to suppliers 16.

Prior Step: 4.3.2 (Set up rules).

Input: A set of chosen suppliers 16 to be involved in the auction and the business rules set-up for that auction. (Can preferably be enhanced by additional instructions issued by representative 12).

Activity: Claims fulfillment system 18 sends instructions to bid to suppliers 16, typically by their preferred technology.

Output: Information about the auction and how to bid are received by each of suppliers 16 involved in the auction.

Owner: Claims fulfillment system 18.

Next Step: 4.3.4 (Supplier survey).

Step 4.3.4 Suppliers 16 ascertain whether they have enough information to bid.

Prior Step: 4.3.3 (Instructions to bid).

Input: Supplier 16 receive an invitation to bid.

Activity: Supplier 16 receiving the invitation analyze the information (specification) contained in the instruction to bid.

Output: N/A.

Owner: Supplier 16.

Next Step: 4.3.6 (Auction), 4.3.5 (More detail).

Step 4.3.5 Suppliers 16 gather more detail about the service required.

Prior Step: 4.3.4 (Supplier survey).

Input: A supplier 16 receives an invitation to bid, but doesn't have a detailed enough specification with which to compile a bid.

Activity: The supplier 16 gathers more information about the service required, e.g. through an on-site visit or through a more detailed discussions with representative 12 and/or claimant 14.

Output: A detailed specification that the supplier 16 can bid against.

Owner: Supplier.

Next Step: 4.3.4 (Supplier survey).

Step 4.3.6 Auction happens according to insurer's business rules and bids are received.

Prior Step: 4.3.4. (Supplier Survey).

Input: Business rules are set up for auction and participants are informed.

Activity: Bids are submitted over the duration set by representative 12.

Output: A list of options and prices.

Owner: Claims fulfillment system 18.

Next Step: 4.5.1 (Options collated).

Step 4.4 Services (Repair/rebuild professional and other services).

Step 4.4.1 Representative 12 decides whether it is an on-catalog service based on the type of claim and service required.

Prior Step: 4.4 (Services).

Input: A service is required to fulfill or partly fulfill a claim.

Activity: Representative 12 decides whether the service required is one that is likely to be on-catalog.

Output: N/A.

Owner: Representative 12.

Next Step: 4.2.1 (On-catalog service), 4.3.1 (Non-catalog service).

Step 4.5.1 Options are typically collated, representative 12 would typically refine options selects and approves and updates claims fulfillment system 18.

Prior Step: 4.2.2 (On-catalog), 4.2.4 (Best fit), 4.3.6 (Auction bids).

Input: An option or list of options for a replacement product/service.

Activity: Claims fulfillment system 18 would typically collate options to resolve the claim by replacement, rebuild, remanufacture or by providing a service. Typically, representative 12 further refines the list of options and selects and approves only those options that insurer 10 would consider acceptable as a replacement for the claimed product/service.

Output: An option or sub-set of options, from which claimant 14 can select (or confirm, whereby confirming could also be considered to be “selecting” by the claimant).

Owner: Claims fulfillment system 18, representative 12.

Next Step: 4.5.2 (Claimant options).

Step 4.5.2 Claims fulfillment system 18 “white-labels” and sends choice to claimant.

Prior Step: 4.5.1 (Collate options).

Input: An option or sub-set of options, from which claimant 14 can select (or confirm).

Activity: Claims fulfillment system 18 sends the option or set of options to claimant 14. In a typical embodiment, claims fulfillment system 18 would “whitelabel” the option or set of options, where white-labeling refers to claims fulfillment system 18 presenting information to claimant 14 in the colors and logo of insurer 10.

Output: Typically, a web-view (or e-mail, WAP message, letter etc), typically formatted in the style of insurer 10 displaying the choice(s) available to claimant 14.

Owner: Claims fulfillment system 18.

Next Step: 4.5.3 (Claimant 14 selects option).

Step 4.5.3 Claimant 14 selects the option (or from a list of options) and responds to claims fulfillment system 18 (typically white labeled).

Prior Step: 4.5.2 (Claimant options).

Input: Typically, a web-view (or e-mail, WAP message, letter etc), typically formatted in the style of insurer 10, displaying the choice(s) available to claimant 14 for the replacement of their product/service.

Activity: Claimant 14 decides which option to select and informs claims fulfillment system 18, typically via their preferred technology.

Output: An order for a replacement product/service as selected (confirmed) by claimant 14.

Owner: Claimant 14

Next Step: 4.5.4 (Logistics options), 4.5.5 (Claimant refuses options), 4.5.6 (Claimant selects option).

Step 4.5.4 If the logistics are not acceptable to claimant 14 a different option would typically be arranged by representative 12.

Prior Step: 4.5.3 (Claimant selects option).

Input: Claimant 14 confirms that they accept one of the options available, but they can not accept delivery of the product/service at the time assigned by the service providers.

Activity: Representative 12 selects the same option, but with a different delivery date (and possibly supplier, depending on availability).

Output: The same product/service, but with a different delivery date (and possibly supplier).

Owner: Representative 12.

Next Step: 4.5.3 (claimant 14 selects option).

Step 4.5.5 Claim is handled manually and procurement is tracked through claims fulfillment system 18.

Prior Step: 4.5.3 (Claimant selects option).

Input: Claimant 14 refuses all options offered by representative 12.

Activity: The claim is processed manually. Procurement would typically be tracked through claims fulfillment system 18 (for analysis and reporting) although procurement may be for a non-catalog product or service.

Output: The manual fulfillment of a claim.

Owner: Representative 12.

Next Step: N/A.

Step 4.5.6 Claims fulfillment system 18 receives authorization from insurer 10 to proceed.

Prior Step: 4.5.3 (Claimant selects option).

Input: The product/service to be procured has been agreed by claimant 14.

Activity: If required, claims fulfillment system 18 would typically obtain authorization to proceed from insurer 10.

Output: An agreement from insurer 10 to proceed with the procurement; or the need to obtain more senior authority from insurer 10.

Owner: Insurer 10.

Next Step: 4.5.7 (Insurer authorization), 4,5,8 (Instruct supplier).

Step 4.5.7 Authorization process.

Prior Step: 4.5.6 (Request authorization).

Input: The need to obtain more senior authority from insurer 10 to approve the level of procurement.

Activity: Insurer 10 obtains the approval from a higher authority.

Output: The approval from insurer 10 to procure a particular level of product/service.

Owner: Insurer 10.

Next Step: 4.5.6 (Receive authorization).

Step 4.5.8 Claims fulfillment system 18 (typically white-labeled) instructs supplier 16 to proceed.

Prior Step: 4.5.6 (Receive authorization).

Input: The order for the service to be supplied.

Activity: Claims fulfillment system 18 send a message, typically white-labeled, to supplier 16 to proceed with the delivery of the service. Here, white-labeling refers to claims fulfillment system 18 presenting information to supplier 16 in the colors and logo of insurer 10.

Output: The order, typically white-labeled, is sent to the supplier 16 to proceed.

Owner: Claims fulfillment system 18.

Next Step: 4.5.9 (Supplier decides whether to procure).

Step 4.5.9 Supplier 16 ascertains if they have a need to procure goods or services themselves in order to fulfill the delivery of their good or service.

Prior Step: 4.5.8 (Instruct supplier).

Input: The supplier 16 has been sent an order to proceed with the execution of the service.

Activity: The supplier 16 compiles a list of goods or services that they require in order to carry out the work, e.g., a builder might require the services of an electrician and raw materials from a merchant.

Output: A list containing goods or services that need to be procured to deliver the service.

Owner: Supplier 16.

Next Step: 4.5.10 (Supplier procure), 4.5.11 (Place order).

Step 4.5.10 Supplier 16 carries out procurement through claims fulfillment system 18 (as if representative 12).

Prior Step: 4.5.9 (Supplier 16 decides whether to procure).

Input: A list containing goods or services that need to be procured, as a sub-set of the service to be supplied by the supplier 16.

Activity: Supplier 16 has access to an appropriate sub-set of the insurer's negotiated contracts and procures the goods or services that they require. Preferably, all goods or services that can be procured on-contract though the insurer's suppliers are handled this way.

Output: Claims fulfillment system 18.

Owner: Supplier 16, representative 12.

Next Step: 4.1.2 (Initiate procurement).

Step 4.5.11 Claims fulfillment system 18 aggregates and places orders with suppliers 16.

Prior Step: 4.5.9 (Suppler 16 decides whether to procure).

Activity: Claims fulfillment system 18 aggregates and places orders with suppliers 16.

Output: An instruction to place an order.

Owner: Claims fulfillment system 18.

Next Step: 4.6.1 (Confirm delivery date).

Step 4.6.1 Supplier 16 confirms delivery date to claims fulfillment system 18.

Prior Step: 4.5.11 (Place order).

Input: A list of line items to be procured from a particular supplier 16.

Activity: The supplier 16 confirms the delivery date for the particular line item associated with the claim.

Output: A confirmed delivery date.

Owner: Supplier 16.

Next Step: 4.6.2 (Route update).

Step 4.6.2 Claims fulfillment system 18 (typically white-labeled) updates claimant 14 and insurer 10 on fulfillment route.

Prior Step: 4.6.1 (Confirm delivery date).

Input: A confirmed delivery date for a particular item associated with a claim.

Activity: Claims fulfillment system 18 passes information on delivery back to insurer 10 and then onto claimant 14 (typically after white-labeling) through, preferably, the technology of choice (e.g. the insurers web page, e-mail, phone (via call center etc.)).

Output: Insurer 10 is informed about the delivery date and a message is received (or is accessible—in the case of the web page) by claimant 14 about the time of delivery.

Owner: Claims fulfillment system 18.

Next Step: 4.6.3 (Tracking), 4.6.4 (Delivery).

Step 4.6.3 Representative 12 and claimant 14 have the ability to track on-line the status of the fulfillment of goods/services ordered through claims fulfillment system 18.

Prior Step: 4.6.2 (Route update), 4.6.4 (Delivery), 4.6.5 (Delivery update).

Input: A confirmed delivery date for the good or service.

Activity: Claimant 14 or representative 12 inquires about the status of their claim through, for example, either call center, web page, e-mail etc.

Output: Based on information received from logistics and/or supplier 16, claims fulfillment system 18 allows claimant 14 or representative 12 to check the status of the claim. Owner: Claimant 14, insurer 10, logistics claims, claims fulfillment system 18.

Next Step: The Prior Step.

Step 4.6.4 Supplier 16 fulfills order and delivers goods/service to claimant 14.

Prior Step: 4.6.2 (Route update).

Input: A confirmed delivery date for the good or service.

Activity: Supplier 16 delivers the good or the service.

Output: The goods or service are delivered to claimant 14.

Owner: Supplier 16.

Next Step: 4.6.5 (Delivery update).

Step 4.6.5 Supplier updates claims fulfillment system 18 when claim is fulfilled.

Prior Step: 4.6.4 (Delivery update).

Input: The good or service has been delivered.

Activity: Supplier 16 updates claims fulfillment system 18 and informs it that the order has been completed.

Output: A confirmation to claims fulfillment system 18 that the order has been completed and a message from claims fulfillment system 18 to insurer 10 that the claim has been fulfilled.

Owner: Supplier 16, claims fulfillment system 18.

Next Step: 4.7.1 (E-bill), and optionally 4.8.1 (Apres claim).

Step 4.7.1 Supplier 16 submits electronic bill to claims fulfillment system 18.

Prior Step: 4.6.5 (Delivery update).

Input: The good or service has been delivered.

Activity: Supplier 16 typically submits an electronic bill for the aggregated total of the goods or services procured from them, typically including the line item for this particular good or service.

Output: An electronic bill, typically including a break down of the line items, is sent to claims fulfillment system 18.

Owner: Supplier 16.

Next Step: 4.7.2 (Aggregate).

Step 4.7.2 Claims fulfillment system 18 aggregates and reconciles invoices across suppliers 16 before forwarding to insurer 10.

Prior Step: 4.7.1 (E-bill).

Input: An electronic bill, typically including a break down of the line items, is sent to claims fulfillment system 18.

Activity: Claims fulfillment system 18 typically checks that the good or service has been satisfactorily received or executed and typically creates a line item on an aggregated electronic bill, across suppliers 16, for a particular insurer to settle (according to the settlement terms in individual supplier contracts).

Output: An aggregated electronic bill due for settlement, typically presented to insurer 10.

Owner: Claims fulfillment system 18.

Next Step: 4.7.3 (Settlement).

Step 4.7.3 Insurer 10 issues instruction to their bank for settlement of the electronic bill and updates claims fulfillment system 18.

Prior Step: 4.7.2 (Aggregate).

Input: Confirmation from claims fulfillment system 18 typically that a line item on an electronic bill is ready for settlement.

Activity: Insurer 10 issues an instruction (typically via secure transmission), typically to their bank, to release funds to supplier 16 for the value of the aggregated line items on the order, against contract.

Output: An instruction to release funds to supplier 16 is received, typically by the insurer's bank. The bank then releases the funds to supplier 16.

Owner: Insurer 10, Bank.

Next Step: 4.7.4 (Receive funds), 4.8.3 (Metrics).

Step 4.7.4 Supplier's bank receives funds and notifies supplier of paid bill and claims fulfillment system 18 is updated to reflect payment.

Prior Step: 4.7.3 (Settlement).

Input: The insurer's bank releases funds to the supplier.

Activity: Supplier's bank typically notifies supplier 16 that funds have been received.

Output: A notification from the supplier's bank.

Owner: Suppliers 16, bank.

Next Step: N/A.

Step 4.8.1 Claims fulfillment system 18 provides “after fulfillment” service, typically white-labeled as insurer 10, to determine claimant satisfaction.

Prior Step: 4.6.5 (Delivery update).

Input: The good or service for the claim are delivered.

Activity: Claims fulfillment system 18 would typically contact claimant 14. Claimant 14 is typically contacted on behalf of insurer 10 and typically answers questions about the level of service received in the execution of the claim. (This can also lead to the offer of sell-on products and services.)

Step 4.8.1 would typically be an optional step. It could happen in parallel with step 4.7.1, and not necessarily after step 4.7.1 as shown in the figure.

Output: A set of quantitative ratings about the service can typically be compiled and used for management reporting. Also a set of qualitative comments on suggestions for improving the service can typically be prepared. The ratings and comments can then be added to the supplier knowledge base.

Owner: Claims fulfillment system 18, insurer 10.

Next Step: 4.8.2 (Metrics).

Step 4.8.2 Claims fulfillment system 18 would typically compile metrics for insurer 10, supplier etc.

Prior Step: 4.7.3 (Settlement), 4.8.1 (Apres Claim).

Input: Preferably all data captured through out the claims process.

Activity: Claims fulfillment system 18 compiles reports and metrics for insurer 10, suppliers 16 etc. (including a number of other value added services).

Output: A set of reports that can be used to negotiate improved contracts with suppliers 16, monitor activity and productivity etc.

Owner: Claims fulfillment system 18.

Next Step: N/A.

Preferably, through the claims fulfillment process, claims fulfillment system 18 keeps a record of the state of each of the goods or services (including goods or services procured through claims fulfillment system 18 as part of a sub-set of an overall service) to be procured in relation to the respective supplier 16, the claim, claimant 14 and insurer 10.

In some embodiments of the present invention, claims fulfillment system 18 might provide only retail price information to claimant 14, but provide both retail and wholesale price information to insurer 10. However, the present invention is not limited to providing pricing information in this manner.

Claims fulfillment system 18 would comprise a processor (not illustrated) running software which implements the steps in FIGS. 2 and 3.

The specific steps in FIGS. 2 and 3 are examples, and not all of the steps, or all of the operations in each respective step, are necessary in all embodiments of the present invention. For example, many obvious variations of the flow chart in FIGS. 2 and 3 can easily be made, and it is intended for the present invention to encompass such obvious variations.

According to various embodiments of the present invention, claims fulfillment system 18 can typically check with claimant 14 to ensure that the claim has been fulfilled (see, for example, step 4.8.1 in FIG. 3). By doing so, claim fulfillment system 18 can improve satisfaction of claimant 14.

Further, according to various embodiments of the present invention, claims fulfillment system 18 can typically allow for the use of an advanced search (see, for example, step 4.2.4 in FIG. 2). For example, an advanced search could be a search that uses pattern recognition and not only use word recognition to find “hits.” There are many other ways to perform an advanced search, and the present invention is not limited to any particular way.

As indicated above, various embodiments of the present invention relate to non-catalog products/services, on-catalog products/services and on-contract products. Generally, on-catalog products/services are those for which an exact match exists in a supplier catalog and for which there is a contract governing their procurement. By contrast, non-catalog products/services are those for which an exact match does not exist in a supplier catalog and for which there is no contract governing their procurement. On-contract products are products that exists in a supplier catalog (meaning a contract exists for their procurement) or a supplier with whom contract or discounted rates have been agreed.

In the above embodiments of the present invention, claimant 14 is provided with a product and/or service in fulfillment of a claim. However, in some cases, claimant 14 could be provided with cash, or preferably an electronic voucher that can be used to purchase goods and/or services from suppliers 16. For example, in step 4.5.5 in FIG. 2, claimant 14 has refused the presented options for goods and/or services. Therefore, in this case, claimant 14 might be given an electronic voucher in fulfillment of the claim. The electronic voucher might allow claimant 14 to purchase any goods and/or services from suppliers 16 that are offered. However, in a typical embodiment, claimant 14 would be restricted to purchasing only specific goods or services offered by suppliers 16 and that have some relationship to the type of item that was insured.

Various embodiments of the present invention relate to “white-labeling,” which refers to presenting information to a third party using the colors and logo of, and the branding of, the party that the third party is being contacted on behalf of. For example, when claims fulfillment system 18 “white labels” information presented by claims fulfillment system 18 to claimant 14, claims fulfillment system 18 presents the information using the colors and logo of, and branding of, insurer 10. However, the present invention is not limited to the use of white-labeling. Instead, there are many different manners and formats in which information can be presented.

As can be seen from the above, claims fulfillment system 18 provides significant benefits. For example, claims fulfillment system 18 enables control over fulfillment of the claim to be taken at an early stage by insurer 10. This has the effect of reducing claims leakage and reducing fraud potential. Moreover, claims fulfillment system 18 automates the procurement process, to thereby reduce procurement processing costs. Further, claims fulfillment system 18 enforces more on-contract procurement, thereby increasing procurement leverage (across the community) and reducing procurement spending. Generally, claims fulfillment system 18 makes significant improvements to cost, efficiency, customer service and delivery in fulfilling an insurance claims.

The above embodiments of the present invention relate to an insurer which insures an item. Here, the insurer would typically be an insurance company. However, the present invention is not limited to the insurer being an insurance company. Instead, the insurer could be virtually any type of company, organization, financial institution or entity which provides insurance.

Moreover, the above embodiments of the present invention relate to a representative of the insurer, such as representative 12 in FIG. 1. Here, a representative refers to an entity which acts on behalf of the insurer. Typically, the representative would be an employee of the insurer, but the present invention is not limited to being an employee of the insurer. The representative might be, for example, a contractor hired by the insurer. In some embodiments, it might be possible for the representative to be a software agent working on behalf of the insurer.

According to the above embodiments of the present invention, communication channels connect a claimant submitting an insurance claim for loss of an insured item, an insurer insuring the item, and suppliers, to a claims fulfillment system. The claims fulfillment system automatically coordinates activities between the insurer, the suppliers and the claimant so that the claimant is provided with a claimant-selected product or service by at least one of the suppliers to fulfill the insurance claim. Here, whether the claimant confirms, selects or agrees that a specific product or service can be used to fulfill the insurance claims, the claimant's actions should be considered as “selecting” the product or service.

Thus, the claims fulfillment system “automatically” coordinates activities between the representative, the suppliers and the claimant. Here, the term “automatically” indicates performance by a computer in an automated manner. Thus, the claims fulfillment system coordinates activities between the insurer, the suppliers and the claimant via computer processing in accordance with data received from, and provided to, the insurer, the suppliers and the claimant by the claims fulfillment system.

The present invention relates to the use and management of electronic catalogs. Electronic catalogs are known, and there are various known systems for using and managing electronic catalogs.

In some embodiments, claims fulfillment system 18 could allow parties other than claimant 14 or insurer 10 to purchase goods or services from suppliers 16. For example, generally, all insurance policy holders of insurer 10 might be allowed to purchase goods or services from suppliers 16, to thereby allow the policy holders to take advantage of the buying power provided by claims fulfillment system 18. Typically, the filing of a claim by a policy holder would draw the policy holder to claims fulfillment system 18, and may be a catalyst for additional purchases, or future purchases by the policy holder through claims fulfillment system 18. Of course, parties other than policy holders might be allowed to purchase goods or services through claims fulfillment system 18. Typically, such other parties would be customers of insurer 10, or might be members of a community of users provided access to claims fulfillment system 18.

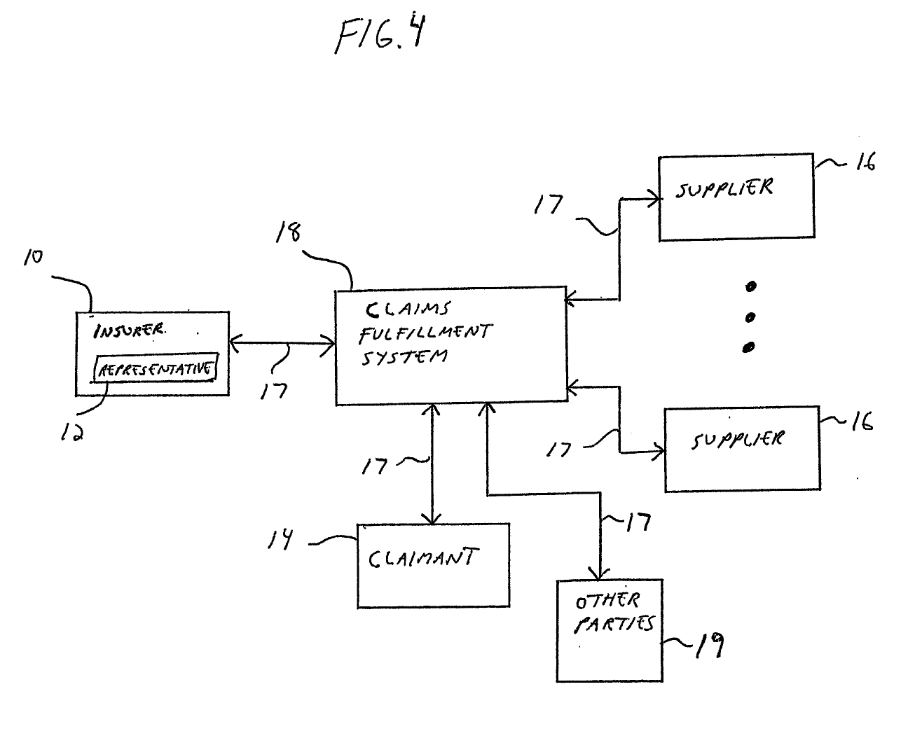

As an example, FIG. 4 is a diagram illustrating other parties 19 connected to claims fulfillment system 18 through a communication channel 17, according to an embodiment of the present invention. As indicated above, other parties 19 are allowed to electronically purchase goods or services from suppliers 16 through claims fulfillment system 18.

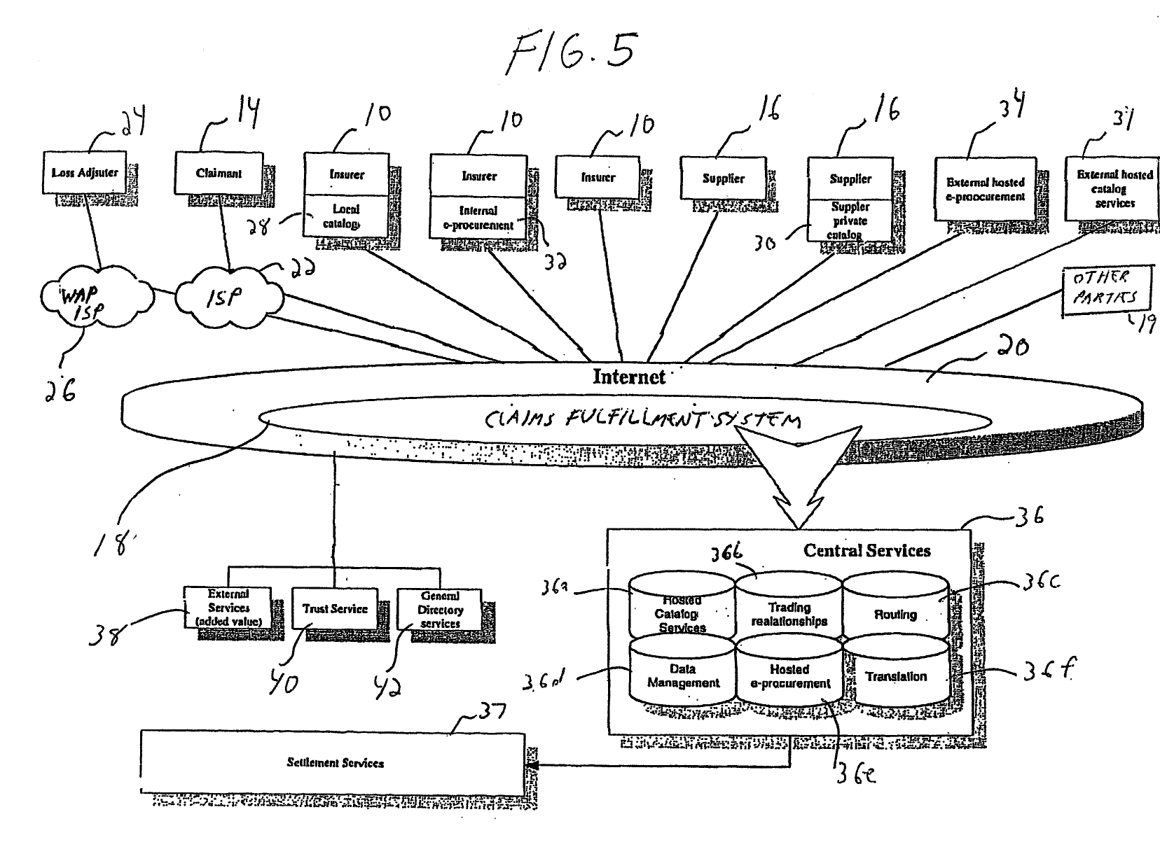

FIG. 5 is a diagram illustrating an overall architecture for implementing claims fulfillment system 18, according to an embodiment of the present invention. Referring now to FIG. 5, claimant 14, a plurality of insurers 10 and a plurality of suppliers 16 are connected to claims fulfillment system 18 via the Internet 20. In the example of FIG. 5, claimant 14 accesses the Internet 20 via an Internet Service Provider (ISP) 22. A loss adjuster 24 is shown as accessing claims fulfillment system 18 via a Wireless Application Protocol (WAP) or an ISP 26. As illustrated in FIG. 5, various insurers 10 might have a local catalog 28, while some suppliers 16 might have a supplier private catalog 30. External hosted catalog services 31 might also be provided.

An insurer 10 might provide the capability for internal e-procurement 32. External hosted e-procurement 34 might also be provided.

Claims fulfillment system 18 could typically provide central services 36, such as hosted catalog services 36a, trading relationships 36b, routing 36c, data management 36d, hosted e-procurement 36e and translation 36f. Settlement services 37 might also be provided.

Further, claims fulfillment system 18 might also provide external services (added value) 38, trust service 40 and/or general directory services 42. External services 38 might be, for example, logistics information, consumer information (i.e., comparisons of consumer goods), jewelry valuation services.

Of course FIG. 5 represents only one of the many possible architectures and different types of services which might be implemented, and the present invention is not limited to this specific example.

As can be seen from the above, various embodiments of the present invention will reduce claims leakage, reduce fraud and reduce procurement processing costs, as compared to traditional approaches to claims fulfillment.

Further, various embodiments of claims fulfillment system 18 can be used to improve additional aspects of claims fulfillment. For example, consider the motor repair industry. A large proportion of the motor repair industry's business comes from fulfilling insurance claims. With conventional fulfillment of insurance claims, insurers typically negotiate deals with either single repair shops (i.e., “suppliers”), or multiple repair consolidators, to control costs. These deals have squeezed the profits of the repair shops, with whom the insurers will insist give a discount if they want any business at all. At the same time the insurers are demanding a higher quality of repair which requires substantial investment by the repair shop in new machinery such as, for example, a paint-drying oven. As an example, after an investment by the repair shop which reduces a three hour process to a one hour process, the insurers' response would typically be to pay the repair shop for just one hour of labor. It is clear that if insurers want to continue to drive discounts in this area they cannot just keep squeezing the repair shops for a reduction in cost.

To solve such problems, as described in more detail below, in some embodiments of the present invention, claims fulfillment system 18 could be used, for example, to aggregate claims fulfillment volume from multiple insurers 10 for future periods, and to reverse auction the aggregated claims fulfillment volume to suppliers 16 who would bid with discounts.

Moreover, in some embodiments of the present invention, claims fulfillment system 18 could, for example, balance the load between the actual claims fulfillment volume delivered from insurers 10 and the claims fulfillment volume promised to suppliers 16, thereby minimizing procurement risk. Procurement risk is defined as the ability to balance the demand, or amount of business that is predicted will be needed to fulfill claims, against the greater level of discount achievable if that predicted level can be higher. The risk is minimized by being able to predict as close to the maximum demand as possible, without exceeding it, thereby being able to guarantee as high a level of future business as possible. Procurement risk is not limited to only such a definition, but also encompasses any risk of not being able to achieve the highest level of discount possible, for whatever reason.

As a result of such reverse auctioning and load balancing, claims fulfillment system 18 could generate genuine assets for suppliers 16 in terms of guaranteed future business, which assets can then be used, for example, by a respective supplier 16 to gain investment, for example, for new or improved machinery or infrastructure. Further, claims fulfillment system 18 could generate discounts for, and reduce claims fulfillment costs of, insurers 10.

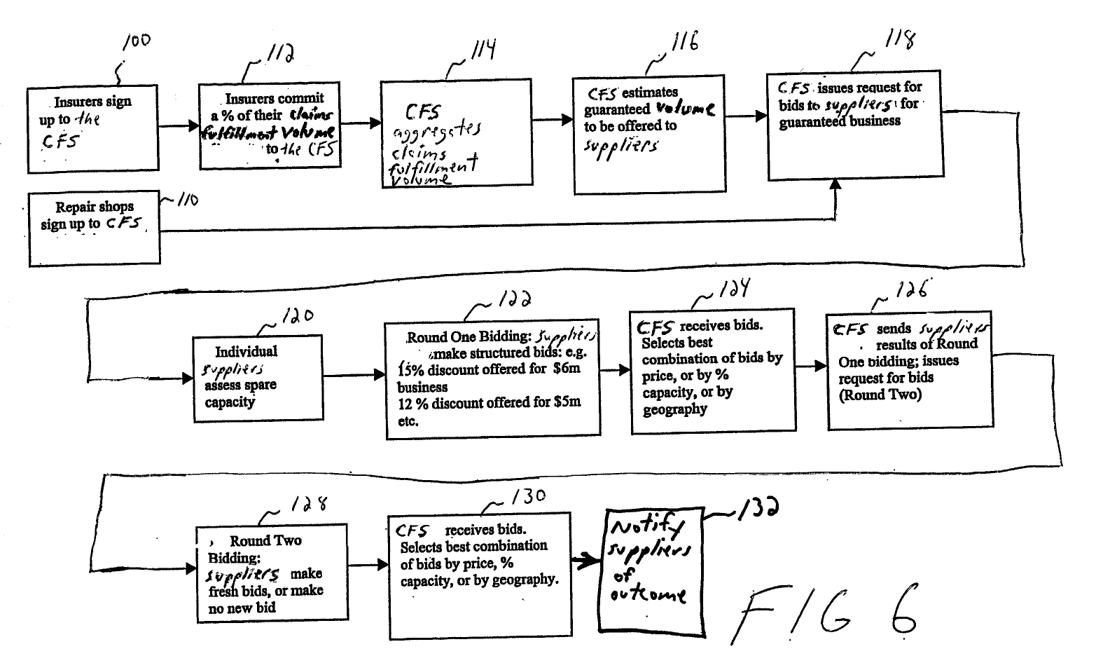

FIG. 6 is a flow chart illustrating the overall operation of claims fulfillment system 18 to provide for the reverse auctioning of future claims fulfillment volume, according to an embodiment of the present invention. The flow chart in FIG. 6 is a specific example relating to the auto repair industry supply chain, but is applicable to other direct and indirect supply chains to the insurance industry. For example, the flow chart is applicable to, but not as an exhaustive list, the health insurance supply chain, aircraft insurance supply chain and legal services supply chain. Moreover, although the flow chart is FIG. 6 shows a specific example of a reverse auction, the present invention is not limited to auctions being “reverse” auctions.

Referring now to FIG. 6, in operation 100, insurers 10 sign up and register to claims fulfillment system (CFS) 18.

In operation 110, suppliers 16 sign up for claims fulfillment system 18. In a typical embodiment, suppliers 16 would have to meet certain minimum standards. As the present example relates to the auto repair industry, it will be assumed that suppliers 16 are, for example, repair shops, and might have to meet, for example, ISO standards for auto-repair shops. Also, in this example, in operation 110, suppliers 16 will be assessed against an econometric model to put a limit on the amount of business they are allowed to bid for, although this principle would apply whatever the supply chain.

Here, an econometric model is a model of the economics of a supplier to determine capacity. For example, an econometric model might predict how different suppliers behave in terms of being able to handle extra volume and would typically be specific to the supply chain.

To make such a prediction, the econometric model might use, for example, numerical data indicating actual capacity, working conditions, actual work on hand, type of equipment, type of work that can be handled by each supplier, etc. The econometric model might use, for example, an assumption that an auto-repair shop can operate at 120% of maximum volume if it is more productive. Such numerical data and assumptions would typically be determined, for example, by actual visits, audits and inspections of the various suppliers. However, the present invention is not limited to such actual visits, audits and/or inspections. For example, the suppliers may be allowed to enter all, or some, of this information into claims fulfillment system 18.

There are many possible econometric models which can be used, and the present invention is not limited to any particular econometric model. The concept of an econometric model is well-known, and the design of a suitable econometric model based on the supply chain would be known to a person of ordinary skill in the art of econometric models. Moreover, the present invention is not limited to the use of an econometric model.

Typically, the econometric model would be created by humans (such as, for example, a person of skill in the art of econometric models), and much of the data input by humans, but the actual computations would typically be performed in an automated manner by claims fulfillment system 18. For example, a processor in claims fulfillment system 18 would perform the actual computations. However, the present invention is not limited to the actual computations being performed by claims fulfillment system 18.

From operation 100, the process moves to operation 112, where insurers 10 commit a percentage of their future claims fulfillment volume. As the present example relates to the auto repair industry, insurers 10 might commit a percentage of their future auto repair claims to claims fulfillment system 18. In a typical embodiment, insurers 10 would agree to commit, for example, all, or a specific portion, of their auto repair claims for fulfillment through claims fulfillment system 18 in metropolitan areas in which claims fulfillment system 18 is operational.

From operation 112, the process moves to operation 114, where claims fulfillment system 18 aggregates claims fulfillment volume from the different insurers. There are many ways for claims fulfillment system 18 to aggregate claims fulfillment volume, and the present invention is not limited to any particular way. However, as an example, claims fulfillment system 18 might aggregate claims fulfillment volume by type and metropolitan area where necessary across participating insurers. For example, white & brown goods (televisions, video, hi-fi equipment, washing machines, microwaves etc.) volume might be aggregated by manufacturer or supplier, whereas auto-repair volume might be aggregated by metropolitan area.

As an example, in operation 114, claims fulfillment system 18 might apply a predictive statistical model to predict total claims to be fulfilled by operational metropolitan area, in accordance with the insurer commitments made in operation 112. Generally, a predictive statistical model is a model used to predict claims for a particular insurer in a particular geographic region. Taking the example of, but not limiting it to, the auto repair supply chain, historical claims data from each participating insurer would be analyzed and using techniques known to insurers and other industries, future claims volume would be estimated for each insurer and then aggregated across insurer by metropolitan area, or supplier or other as demanded by the nature of the supply chain.

There are many possible predictive statistical models which can be used, and the present invention is not limited to any particular predictive statistical model. The concept of a predictive statistical model is well-known, and the design of a suitable predictive statistical model to predict total claims to be fulfilled would be known to a person of ordinary skill in the art of predictive statistical models. Moreover, the present invention is not limited to the use of a predictive statistical model.

Typically, the predictive statistical model would be created by humans (such as, for example, a person of skill in the art of predictive statistical models), and much of the data input by humans, but the actual computations would typically be performed in an automated manner by claims fulfillment system 18. For example, a processor in claims fulfillment system 18 would perform the actual computations. However, the present invention is not limited to the actual computations being performed by claims fulfillment system 18.

From operation 114, the process moves to operation 116, where claims fulfillment system 18 estimates the guaranteed claims fulfillment volume to be offered to suppliers 16. The estimated guaranteed claims fulfillment volume would typically be less than the aggregated claims fulfillment volume in operation 114.

As an example, in operation 116, claims fulfillment system 18 estimates the total guaranteed volume by balancing the amount guaranteed against the savings possible and the amount of capital needed to be held to off-set the procurement risk, using, for example, a risk adjusted return model. For auto-repair, this is done, for example, by metropolitan area. Here, a risk adjusted return model is a model used to determine the level of business that should be auctioned.

The risk adjusted return model used in operation 116 would typically be dependent on the relationship of guaranteed volume and structure of the discounts that relate to that volume. For example, for auto-repair, those discounts would typically only be given by individual repair shops or individual chains of repair shops. Therefore, the risk adjusted return model would typically determine the maximum volume that can be guaranteed in the region(s) that the individual repair shop or repair chain operates, against the discounts that repair-shops can give, to thereby obtain the maximum level of discount. The risk adjusted return model would then work out what the likelihood is of a short fall in that guaranteed volume and would calculate the capital reserves needed to off set that risk.

As an example of risk adjusted return, assume that it is estimated that insurer A will provide $3 million in future claims fulfillment volume, insurer B will provide $2 million in future claims fulfillment volume, and insurer C will provide $1 million in future claims fulfillment volume. Thus, the total estimated future claims fulfillment volume is $6 million. If all of this $6 million is guaranteed to the suppliers, a relatively high discount might be obtained from the suppliers. By contrast, a lower discount would probably be obtained from the suppliers if only $3 million of this $6 million was guaranteed to the suppliers. However, the risk that the guaranteed claims fulfillment volume cannot actually be delivered by the insurers is greater when $6 million is guaranteed as opposed to when $3 million is guaranteed. In the event of the claims fulfillment volume not being delivered, capital reserves or insurance would typically have to be held ready to compensate the suppliers for their loss of income. It is assumed that there will be a cost associated withholding such a reserve. A risk adjusted return model tries to balance the amount of guaranteed future claims fulfillment volume versus the level of discount achievable and the amount of capital reserves or insurance held, while minimizing the risk that the guaranteed claims fulfillment volume cannot actually be delivered by the insurers.

There are many possible risk adjusted return models which can be used in operation 116, and the present invention is not limited to any particular risk adjusted return model. The concept of a risk adjusted return model is well-known, and the design of a suitable risk adjusted return model would be known to a person skilled in the art of risk adjusted return models. Typically, the risk adjusted return model would be created by humans (such as, for example, a person of skill in the art of risk adjusted return models), and much of the data input by humans, but the actual computations would typically be performed in an automated manner by claims fulfillment system 18. For example, a processor in claims fulfillment system 18 would perform the actual computations. However, the present invention is not limited to the actual computations being performed by claims fulfillment system 18. Moreover, the present invention is not limited to the application of a risk adjusted return model, and suitable embodiments of the present invention might not use a risk adjusted return model.

Although an econometric model is described as being used in operation 110, a predictive statistical model is described as being used in operation 114 and a risk adjusted return model is described as being used in operation 116, the present invention is not limited to such a separation in use between an econometric model, a predictive statistical model and a risk adjusted return model. For example, an econometric model may be used in both operations 110 and 116. Moreover, operations 110 and 116 may be combined into a single operation. There are many other variations in the combined use of an econometric model, a predictive statistical model and a risk adjusted return model, and the present invention is not limited to any particular combination or use of such models.

From operation 116, the process moves to operation 118, where claims fulfillment system 18 issues requests for bids to suppliers 16 that are allowed to bid. For auto repair, this is done, for example, in localized metropolitan areas.

From operation 118, the process moves to operation 120, where individual suppliers 16 assess spare capacity to fulfill future volume. In the example of the auto repair industry, this could be, for example, any level of capacity up to the limit as defined by operation 110.

From operation 120, the process moves to operation 122, where Round One bidding occurs. Generally, in operation 120, suppliers 16 would typically be bidding for a “slice” of the total volume offered, based on their currently available capacity, and offer discounts for guaranteed future volume. As auto-repair shops, suppliers 16 might bid, for example, for a slice of the volume within a particular metropolitan area. For example, if a respective repair shop has turn over of $1 million and has capacity to handle 50% of its volume this way, the repair shop might bid for up to its limit, as defined by operation 110, of $500,000 worth of auto repair volume at a 15% discount. In a particular metropolitan area, claims fulfillment system 18 might be offering to suppliers a total of many times more than that auto repair volume.

In operation 122, suppliers 16 might be allowed to submit structured bids. Of course, the present invention is not limited to the submission of structured bids, and non-structured bids may be acceptable. The concepts of structured bidding and non-structured bidding are well-known.

From operation 122, the process moves to operation 124, where claims fulfillment system 18 receives bids from multiple suppliers 16 (for example, within a metropolitan area for auto-repair), compares bids and then works out the best combination of bids (which may be a combination of price, capacity, geography, service, etc.). As an example, a system administrator may be able to select how the best combination should be determined. Alternatively, for example, claims fulfillment system 18 might automatically determine the best combination in accordance with programmed instructions, without allowing a system administrator to make any type of decision or selection.

The concept of determining the best combination of bids, or “best deal,” is well-known. Moreover, there are many different ways to determine the best combination of bids, and the present invention is not limited to any particular way.

From operation 124, the process moves to operation 126, where claims fulfillment system 18 sends suppliers 16 results of Round One bidding, and issues requests to suppliers 16 for further bids. For example, claims fulfillment system 18 updates suppliers 16 on the results of bidding in Round One, stating how much volume the respective suppliers can expect based on the current round of bidding.

From operation 126, the process moves to operation 128, where Round Two of bidding occurs. More specifically, suppliers 16 have the opportunity to make fresh bids if they wish, or to simply make no new bid.

From operation 128, the process moves to operation 130, where claims fulfillment system 18 receives Round Two bids, selects the best combination of the Round Two bids.

From operation 130, the process moves to operation 132, where suppliers 16 are notified of the outcome.

The following is a concrete, numerical example of the operation in FIG. 6. Referring again to FIG. 6, in operation 100, assume that insurers X, Y and Z sign up to claims fulfillment system 18.

Continuing with this example, in operation 110, assume that suppliers (for example, repair shops) A, B, C, D, E and F sign up for claims fulfillment system 18. Moreover, assume that claims fulfillment system 18 is operational in regions 1, 2, 3, 4 and 5 out of a total of ten (10) operation regions. As an example, regions 1, 2, 3, 4 and 5 might be, for example, different regions in the State of California, or different States within the United States. Of course, the present invention is not limited to any specific geographic regions, any specific sizes of geographic regions or any specific countries.

From operation 110, the process moves to operation 112 where insurers X, Y and Z each commit, for example, 100% of their claims fulfillment volume through claims fulfillment system 18 in the regions that claims fulfillment system 18 is operational. Assuming this example relates to fulfilling auto repair claims, insurers would typically be required to define how their committed claims fulfillment volume will be split into specific geographic regions. For example, assuming that insurer X is operational only in regions 1, 2, 3 and 8. Insurer X would only be able to commit 100% of its claims fulfillment volume in those regions in which insurer X and claims fulfillment system 18 are both operational, namely regions 1, 2 and 3. Put another way, insurer X would only be able to commit 100% of its overall claims fulfillment volume less an amount equal to that which insurer X has operational in region 8. Insurer Y might only be operational, for example, in regions 1, 2, 3, 4 and 9 and insurer Z might only be operational, for example, in regions 1, 3, 4, 5 and 10.

From operation 112, the process moves to operation 114 where, based the commitments made by insurers X, Y and Z in operation 112, claims fulfillment system 18 determines that, for example, the total claims volume to be fulfilled by insurers X, Y and Z through claims fulfillment system 18 will be $30 million. Of this $30 million, and based on a predictive statistical model, claims fulfillment system 18 predicts that, for example, $10 million of this total will need to be fulfilled in region 1.

From operation 114, the process moves to operation 116, where claims fulfillment system 18 uses a risk adjusted return model to determine how much of the $10 million to be fulfilled in region 1 will be offered to suppliers with a guarantee that such volume will be provided.

For example, the econometric model might assume that each supplier has a maximum capacity of 120% of its total capacity. Supplier A may have total capacity (100%) equaling $10 million, of which $5 million is currently booked work in progress. Therefore, if supplier A was judged by the econometric model to be able to work at 120%, then it would have maximum capacity of $12 million, and available capacity of up to $7 million. Supplier B may have total capacity (100%) equaling $12 million, of which $3 million is currently booked work in progress. Therefore, if supplier B was judged by the econometric model to be able to work at 120%, it would have maximum capacity of $14.4 million, and maximum available capacity of $11.4 million. Using the same method, assume the supplier C is determined as having a maximum available capacity of $1.2 million, supplier D as having a maximum available capacity of $2.1 million, Supplier E as having a maximum available capacity of $0.7 million and supplier F as having a maximum available capacity of $7 million.

Using this information, the econometric model and the risk adjusted return model, claims fulfillment system 18 might determine that, for example, of the $10 million to be fulfilled in region 1, only $8 million will be offered to suppliers with a guarantee that such volume will be provided.

Claims fulfillment system 18 then determines which of the suppliers can place a bid.

For example, claims fulfillment system 18 might determine that suppliers A, B, C, D and E can place a bid, but that supplier F cannot place a bid, for example, due to unresolved complaints by claimants or insurers for past work performed by supplier F. Alternatively, a system administrator might be provided with relevant information, and then be allowed to select which suppliers can, and cannot, place a bid. There are many reasons why a respective supplier would not be allowed to bid. Such reasons include, for example, complaints by claimants or insurers for past work performed by the supplier, lack of capacity, lack of specialized equipment, etc. Of course, the present invention is not limited to any particular reason.

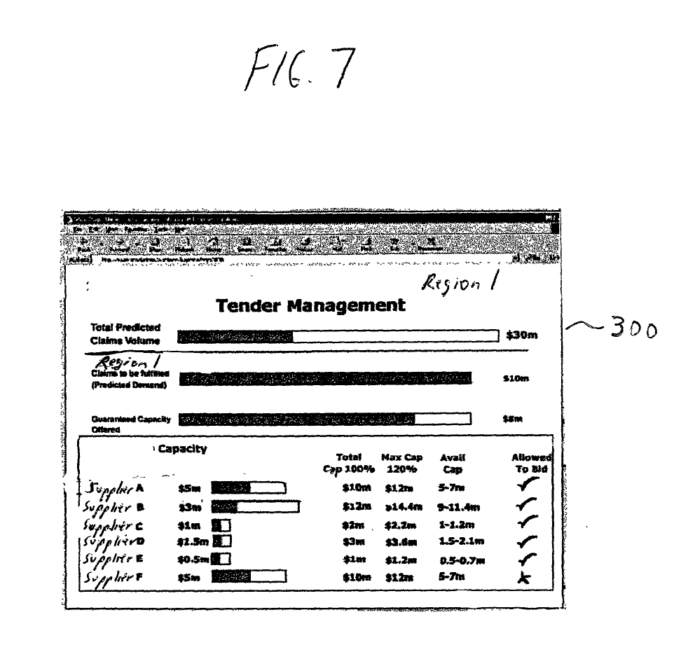

FIG. 7 is a diagram illustrating an example screen display 300 which might be provided by claims fulfillment system 18 through a communications channel to a system administrator in operation 116, according to an embodiment of the present invention. Referring now to FIG. 7, screen display 300 provides a summary of relevant information to the system administrator. Screen display 300 includes a column labeled “allowed to bid.” In this column, claims fulfillment system 18 automatically determines, or the system administrator may be allowed to select, which of the suppliers is allowed to bid. For example, in FIG. 7, screen display 300 shows that suppliers A, B, C, D and E are allowed to bid, but that supplier F is not allowed to bid. Of course, screen display 300 is only an example, and the present invention is not limited to this specific screen display or the specific types of information shown in screen display 300.

From operation 116 in FIG. 6, the process moves to operation 118, where claims fulfillment system 18 issues a request for bid to suppliers A, B, C, D and E.

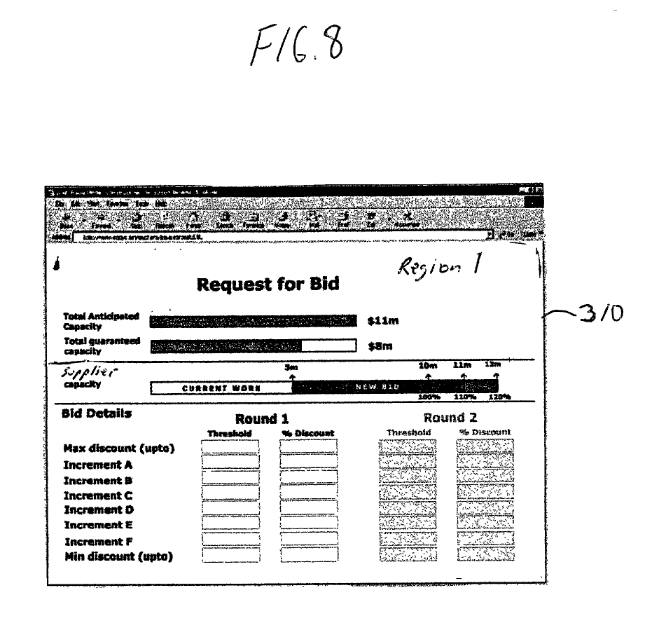

FIG. 8 is a diagram illustrating an example of a screen display 310 of a request for bid sent to supplier A through a communications channel by claims fulfillment system 18 in operation 118, according to an embodiment of the present invention. Of course, screen display 310 is only an example, and the present invention is not limited to this specific screen display or the specific types of information shown in screen display 310.

From operation 118 in FIG. 6, the process moves to operation 120, where suppliers A, B, C, D and E access spare capacity in order to make a bid.

From operation 120, the process moves to operation 122, where suppliers A, B, C, D and/or E submit bids. For example, supplier A makes a structured bid of a 15% discount offered for $6 million in business, a 12% discount offered for $5 million in business, etc., for claims to be fulfilled in region 1. In a typical embodiment, a supplier would be allowed to bid for a maximum amount of claims fulfillment volume which is less than or equal to the respective supplier's maximum available capacity. Therefore, supplier A would be able to bid for a maximum claims fulfillment volume of $7 million.

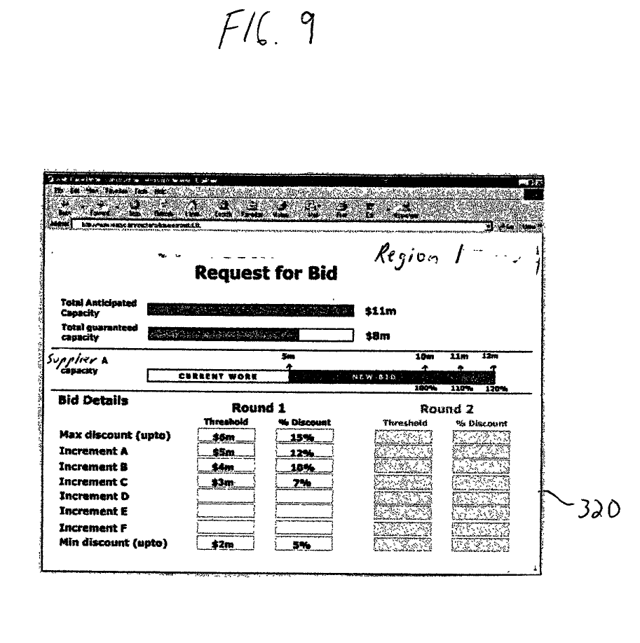

FIG. 9 is an example of a screen display 320 of a completed bid sent by supplier A through a communications channel to claims fulfillment system 18 in operation 122, according to an embodiment of the present invention. Of course, screen display 320 is only an example, and the present invention is not limited to this specific screen display or the specific types of information shown in screen display 320.

From operation 122 in FIG. 6, the process moves to operation 124, where claims fulfillment system 18 determines the best combination of bids.

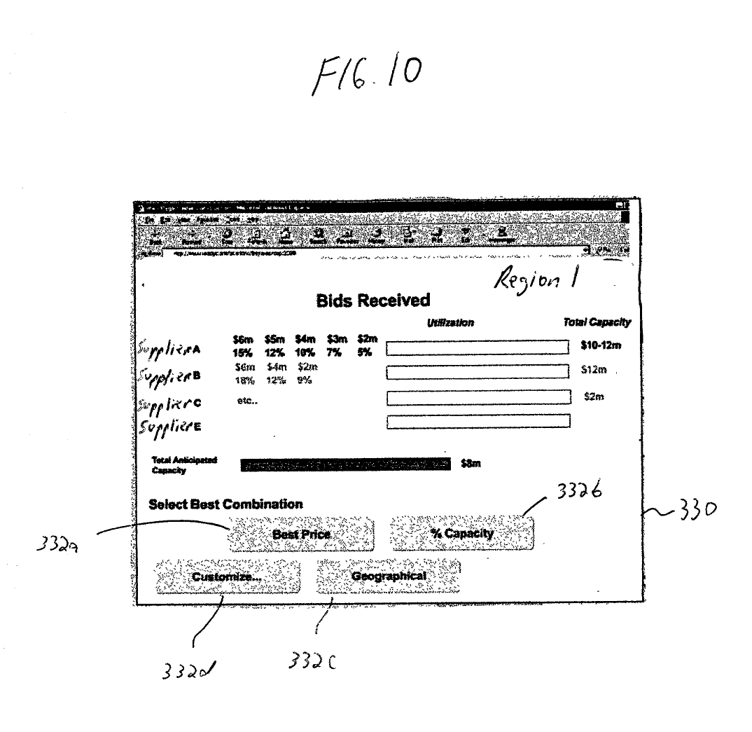

FIG. 10 is an example of a screen display 330 which might be presented to a system administrator by claims fulfillment system 18 through a communications channel in operation 124, to allow the system administrator to determine how the best combination of bids is to be determined, according to an embodiment of the present invention. Screen display 330 summarizes relevant information and allows the system administrator to select how the best combination should be determined. For example, screen display 330 includes virtual buttons 332a, 332b and 332c to allow the system administrator to select whether the best combination should be determined based on best price, % capacity or geographically, respectively. In addition, in this example, screen display 330 includes a virtual button 332d which allows the system administrator to customize the manner in which the best combination is to be determined. Of course, screen display 330 is only an example, and the present invention is not limited to this specific screen display or the specific types of information shown in screen display 330, nor is the operation limited to an automated process. For example, the decision and criteria for making that decision may be a manual process resulting in the manual selection of suppliers used to fulfill the business.

In operation 124 of FIG. 6, in this example, it is assumed that the best combination will be determined to achieve the best price. Therefore, claims fulfillment system 18 may determine that, for example, the best combination for region 1 is to accept the bid for region 1 of $2 million at 5% discount from supplier A, and $6 million at 18% discount from supplier B. This bid combination meets the $8 million of guaranteed claims fulfillment volume for region 1 to be offered by claims fulfillment system 18. Therefore, in this example, the other bids for region 1 by the other suppliers are rejected. In this example, only one bid from each supplier can be selected.

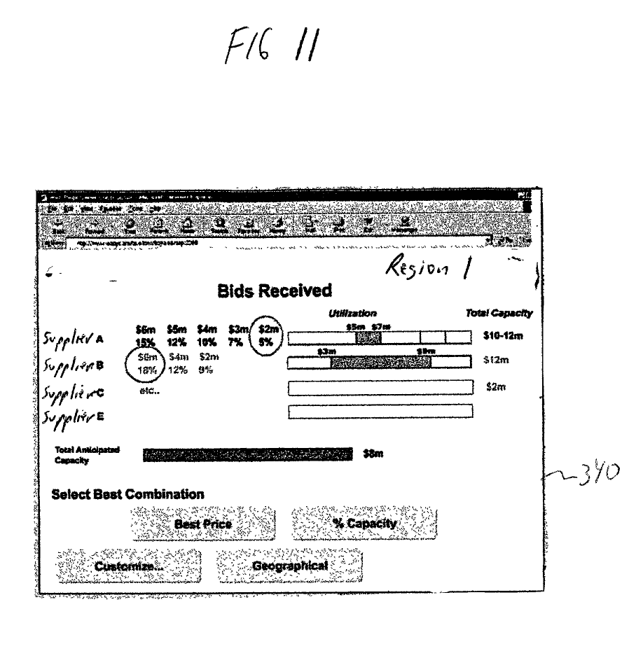

FIG. 11 is a diagram illustrating an example of a screen display 340 presented to the system administrator by claims fulfillment system 18 in operation 124, to indicate which bids were selected as the best combination, according to an embodiment of the present invention. Of course, screen display 340 is only an example, and the present invention is not limited to this specific screen display or the specific types of information shown in screen display 340.

From operation 124, the process moves to operation 126, where claims fulfillment system 18 sends suppliers 16 results of Round One bidding, and issues requests to suppliers 16 for further bids.

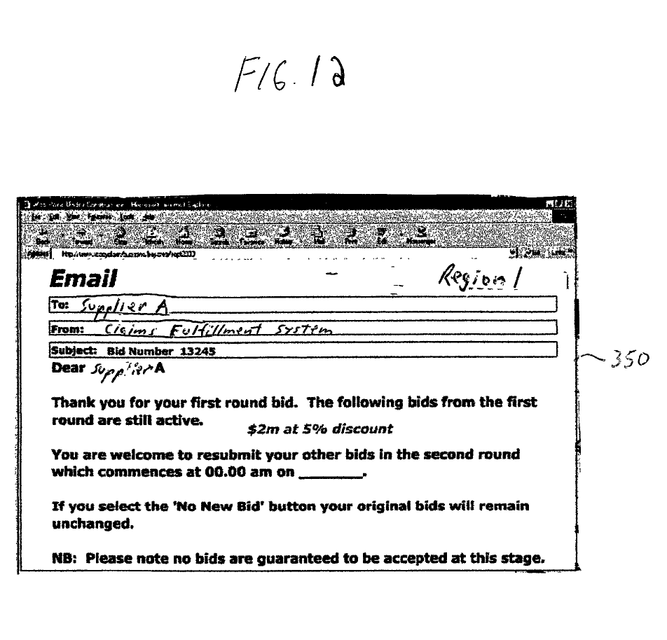

FIG. 12 is a diagram illustrating an example of a screen display 350 of an email sent by claims fulfillment system 18 through a communications channel in operation 126, to notify suppler A that one of its bids is still active, according to an embodiment of the present invention. Of course, screen display 350 is only an example, and the present invention is not limited to this specific screen display or the specific types of information shown in screen display 350, or that the communications channels be via the Internet or e-mail.

From operation 126, the process moves to operation 128, where Round Two of bidding occurs.

From operation 128, the process moves to operation 130, where claims fulfillment system 18 receives Round Two bids, and selects the best combination of bids.

From operation 130, the process moves to operation 132, where the suppliers are notified of the outcome.

The specific operations FIG. 6 are examples, and not all of the operations are necessary in all embodiments of the present invention. For example, many obvious variations of the flow chart in FIG. 6 can easily be made, and it is intended for the present invention to encompass such obvious variations.

In some embodiments of the present invention, claims fulfillment system 18 would typically perform load balancing between insurers 10 and suppliers 16. More specifically, claims fulfillment system 18 would balance the actual claims from insurers 10 with the volume guaranteed to suppliers 16, and accordingly route the actual claims to suppliers 16. For example, when an actual repair insurance claim needs to be fulfilled, the claim will pass to claims fulfillment system 18 from the responsible insurer 10. In some embodiments of the present invention, for example, claims fulfillment system 18 might automatically assign the claim to one of the suppliers (i.e., repair shops) 16 with whom guaranteed future volume has been allocated within a particular metropolitan area. Alternatively, for example, claims fulfillment system 18 might simply present a list of approved suppliers to claimant 14 (see FIG. 1), where the approved suppliers are of those that won bids for future claims fulfillment volume. Claimant 14 could then select a respective supplier from the list. In some embodiments of the present invention, for example, claimant 14 may be allowed to select a supplier from the list, or to select a different supplier not on the list. In such an embodiment, claimant 14 might be provided with incentives to select a supplier from the list. Alternatively, for example, claimant 14 might be provided with, for example, but not limited to, the repair turn-around times of suppliers 16, allowing claimant 14 to select a supplier from the list for this or other reasons that claimant 14 would consider in ordinarily making a choice. There are many ways for claims fulfillment system 18 to allocate actual claims to suppliers 16, and the present invention is not limited to any particular way.

Claims fulfillment system 18 would comprise a processor (not illustrated) running software which implements the operations in FIG. 6.

By awarding future claims fulfillment volume through a reverse auction process, claims fulfillment system 18 has created a virtuous circle. Insurers 10 benefit by achieving discounts from suppliers 16. Suppliers 16 know they have guaranteed future volume and can therefore generate real discounts by the improved productivity created by knowing what their future business will be. Suppliers 16, who now have secured future business, can also use that secured business as an asset to gain investment to expand or for new machinery.

The guarantee of future volume carries an inherent risk of not being able to meet that volume. By balancing the claims fulfillment volume from multiple insurers, it is possible to predict (within limits) an overall volume that can be guaranteed because it is very unlikely that they will all experience a short fall of volume at the same time. Using a risk adjusted return model, claims fulfillment system 18 balances the load between participating insurers 10 to achieve the highest guaranteeable volume possible, thus enabling the best discounts possible.

Various of the above embodiments of the present invention relate to reverse auctions. In a reverse auction, the supplier does the bidding. For example, as illustrated in FIG. 6, claims fulfillment system 18 provides a reverse auctioning process in which suppliers 14 do the bidding. The concept of a reverse auction is well-known.

Moreover, there are many different, well-known ways of performing a reverse auction, and the present invention is not limited to any particular way, and is clearly not limited to the specific example in FIG. 6. For example, although the example in FIG. 6 shows two rounds of bidding, the present invention is not limited to any particular number of rounds. There are many other variations of a reverse auction which can be implemented.

Further, the present invention is not limited to the auction being a “reverse” auction, and many other auction types can be used. Therefore, claims fulfillment system 18 might typically implement other types of auctions to auction future claims fulfillment volume.

As an example, the auction capabilities of claims fulfillment system 18 could be based, for example, on the ARIBA DYNAMIC TRADE product. As an example, for the auto repair market, claims fulfillment system 18, based on the ARIBA DYNAMIC TRADE product, would typically be able to support the auction and repair job allocation process with the additional of an e-claims fulfillment auto repair component. Of course, the present invention is not limited to being based on the ARIBA DYNAMIC TRADE product.

As indicated above, a system administrator might be able to communicate with claims fulfillment system 18 through a communication channel.

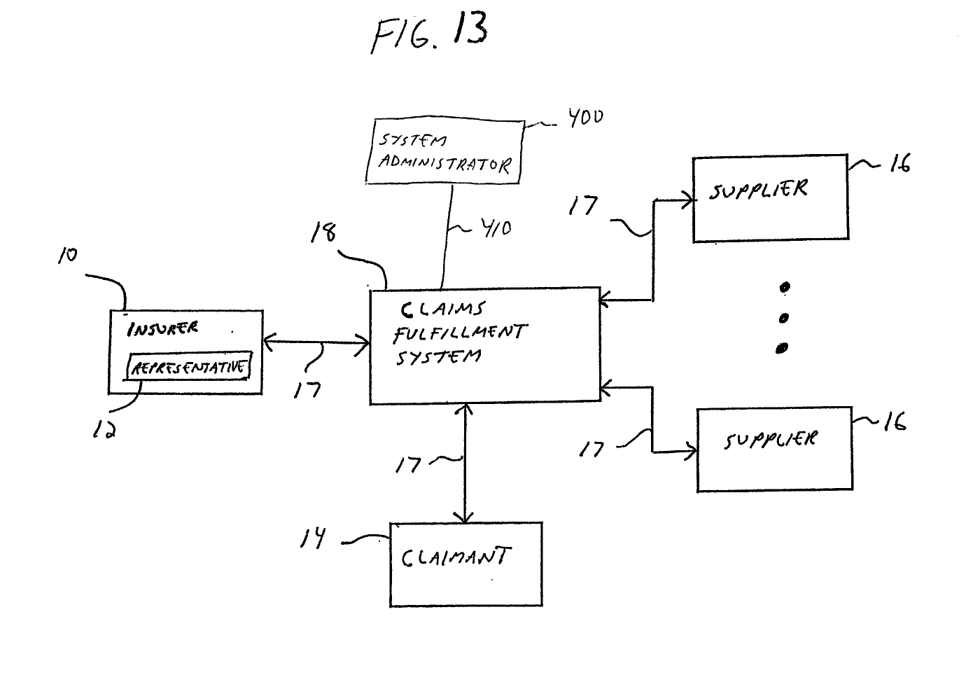

For example, FIG. 13 is a diagram illustrating a system administrator 400 communicating with claims fulfillment system 18 through a communications channel 410, according to an embodiment of the present invention. Communication channel 410 might comprise public and/or private networks, the Internet, local area networks (LANs), wide area networks (WANs), optical communication networks, wireless communication networks, other types of electronic networks, etc. Such a communication channel would typically allow computer communications therethrough, and can therefore be referred to as a computer communications channel.

The term “system administrator” as used herein simply indicates a person that interacts with claims fulfillment system 18 is a manner described herein. This term is not intended to imply a specific level or any other specific responsibilities within an organization.

In a typical embodiment, claims fulfillment system 18 would be integrated with front and back office systems of insurers 10 and suppliers 16. In order for claims fulfillment system 18 to drive maximum value, it should be tightly integrated with insurers 10 and suppliers 16 through, for example, the establishment and adoption of standards.

For example, claims fulfillment system 18 would typically have an open architecture based on industry standards, such as, for example, XML, Universal Standard Products and Services Classification (UNSPSC), UN/EDIFACT, ANSI X12 (810,832 & 850), CIF (catalog interchange format), etc. However, the present invention is not limited to any particular standards, computer languages or protocols.

In a typical embodiment, claims fulfillment system 18 would be a top-down, multi-layered, open and scalable solution that leverages the power of e-procurement and e-aggregation technology in the insurance claims fulfillment marketplace.

Claims fulfillment system 18 is described above as being applicable to the auto repair industry to fulfill auto insurance claims. However, the present invention is not limited to the auto repair industry, and claims fulfillment system 18 can be used to fulfill virtually any type of insurance claim. For example, claims fulfillment system 18 can be used to fulfill insurance claims for home repair services, medical services, legal services, claims appraisal services, car towing services, car rental services, logistics services, etc. Moreover, claims fulfillment system 18 is not limited to fulfilling insurance claims for “services,” and can be used to fulfill insurance claims for “goods.”

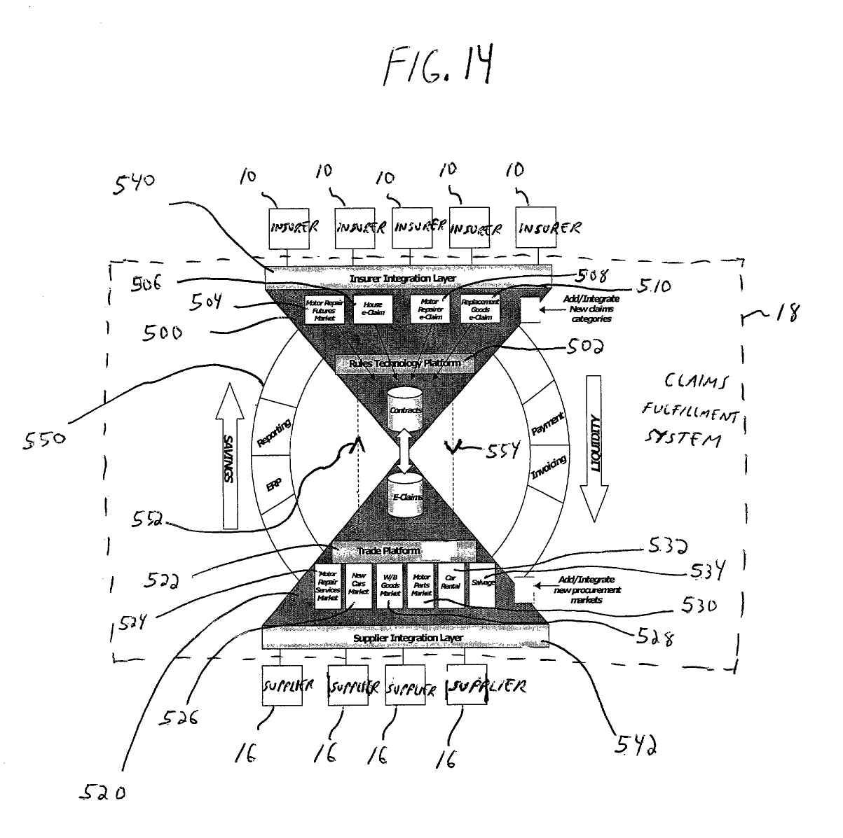

FIG. 14 is a diagram illustrating a possible architecture of claims fulfillment system 18 for integrating insurers 10 and suppliers 16, according to an embodiment of the present invention. Referring now to FIG. 14, claims fulfillment system 18 includes an e-claims fulfillment layer 500. E-claims fulfillment layer 500 includes a rules technology platform 502 which might be, for example, a BLAZESOFT rules engine provided by BLAZE SOFTWARE INC., or might be, for example, STRATA provided by AMERICAN MANAGEMENT SYSTEMS, INC. E-claims fulfillment layer 500 might also include, for example, a motor repair futures market component 504 for processing electronic claims relating to future claims fulfillment volume in the motor vehicle insurance, a house e-claim component 506 for processing actual electronic claims relating to home insurance, a motor repair e-claim component 508 for processing electronic claims relating to automobile insurance and a replacement goods e-claim component 510 for processing actual electronic claims relating to 25 other types of insurance loss. Of course, component 504, 506, 508 and 510 are only examples of the types of components, and the present invention is not in any way limited to these specific types of components.

An e-procurement layer 520 delivers, for example, catalog-based market functionality supporting commodity and service procurement for claims fulfillment. E-procurement layer 520 might be based, for example, on ARIBA MARKETPLACE integrated with ARIBA COMMERCE SERVICES NETWORK, provided by ARIBA INC. E-procurement layer 520 would typically include a trade platform 522 which might be, for example, ARIBA DYNAMIC TRADE provided by ARIBA INC. E-procurement layer 520 might include, for example, a motor repair services market component 524 for purchasing future claims fulfillment of motor repair services, a new car market component 526 for purchasing new cars, a white/brown (W/B) goods market component 528 for purchasing white/brown goods, a motor parts market component 530 for purchasing motor vehicle parts, a car rental component 532 for purchasing car rentals and/or a salvage component 534 for purchasing other goods/services. Of course, component 524, 526, 528, 530, 532 and 534 are only examples of the types of components, and the present invention is not in any way limited to these specific types of components.

Therefore, e-procurement layer 520 would typically be an open architecture enabling easy integration with suppliers, catalog compilers and other e-procurement markets and supply chain execution service providers. Such an architecture would typically be scalable to enable horizontal expansion through the addition of other procurement markets as they are needed for claims fulfillment with minimum additional technical infrastructure or development cost.

An insurer integration layer 540 provides interfaces between claims fulfillment system 18 and insurers 10. Similarly, a supplier integration layer 542 provides interfaces between claims fulfillment system 18 and suppliers 16. Interfaces provided by insurer integration layer 540 and supplier integration layer 542 would typically be standard adaption interfaces.

A claims reporting interface 550 might be provided, for example, to feed back into the insurer enterprise resource planning (ERP) and management reporting systems. A rules interface 552 might be provided, for example, for modeling insurer-based fulfillment rules. An interface 554 would also be provided between e-claims fulfillment layer 500 and e-procurement layer 520.

As indicated above, claims fulfillment system 18 balances the actual claims from insurers 10 with the volume guaranteed to suppliers 16, and accordingly routes the actual repair jobs to the suppliers. Such balancing would typically be performed in accordance with business rules that are automatically executed by a computer. As an example, such business rules would be executed by rules technology platform 502. Typically, the business rules would be defined by a human in advance, but executed by rules technology platform 502. However, it may be possible to automatically create business rules by a computer, and then automatically execute the business rules by a computer. Thus, the present invention is not limited to business rules being created in any specific manner.

It should be understood that FIG. 14 illustrates only one possible architecture, and the present invention is not limited to this architecture. Many obvious variations could easily be created.

As indicated above, claims fulfillment system 18 obtains information relating to the various suppliers 16. Such information might include, for example, the total capacity of the supplier and the amount of capacity currently being used by the supplier. Of course, these are only examples of the type of information which might be obtained, and the present invention is not limited to any specific type of information.

Further, the information relating to the various suppliers 16 can be obtained by claims fulfillment system 18 in different ways. In a typical embodiment of the present invention, a supplier auditor would be sent to each supplier 16 to audit the supplier's facilities. In this manner, the auditor can determine, for example, the total capacity of each supplier 16 and the amount of capacity currently being used. The auditor might also rate, for example, the quality, effectiveness and customer satisfaction of each supplier 16. All this information can then be entered into claims fulfillment system 18 by, for example, the auditor or a system administrator. Further, in some embodiments of the present invention, the suppliers may be able to determine and/or enter some, or all, of this information into claims fulfillment system 18.

As indicated above, claims fulfillment system 18 can be used to treat insurance claims fulfillment volume as a future asset, and to guarantee the future claims fulfillment volume to suppliers. Here, the actual risk of the “guarantee” not being fulfilled could be born, for example, by insurers 16, by the owner/operator of claims fulfillment system 18 or possibly by a third party guarantor. However, the present invention is not limited to what party is actually responsible for the guarantee.

Moreover, in some embodiments of the present invention, claims fulfillment system 18 can be used to trade futures volumes as tradable assets between suppliers 16, and possibly between other parties

As indicated above, claims fulfillment system 18 provides many benefits to insurers 10. For example, according to various embodiments of the present invention, claims fulfillment system 18 can (a) provide access to discounts from an approved supplier network, (b) provide improvements in customer service, more choice, better standards of work, (c) provide procurement leverage on the same or better basis than the biggest insurers, (d) provide opportunities for fraud reduction through a membership system, volume leverage and standards auditing, and (e) provide for parts and service discounts from suppliers 16 without interference in the repair/replacement process.

Moreover, as indicated above, claims fulfillment system 18 provides many benefits to suppliers 16. For example, according to various embodiments of the present invention, claims fulfillment system 18 can (a) generate genuine assets for suppliers 16 in terms of guaranteed future business, and (b) allow suppliers 16 an easy way to generate business and effectively use their capacity.

As indicated above, in some embodiments of the present invention, claims fulfillment system 18 could, for example, balance the load between the actual claims fulfillment volume delivered from insurers 10 and the claims fulfillment volume promised to suppliers 16, thereby minimizing procurement risk. More specifically, greater discounts can typically be obtained from suppliers 16 by guaranteeing a greater amount of future claims fulfillment volume to suppliers 16. However, a greater procurement risk would typically be incurred by guaranteeing a greater amount of future claims fulfillment volume, as the risk will typically be increased that such future claims fulfillment volume cannot actually be delivered. Therefore, claims fulfillment system 18 may be able to minimize the procurement risk by balancing the load between actual claims fulfillment volumes delivered from insurers 10 and the claims fulfillment volume promised to suppliers 16. Here, procurement risk is defined as the risk that an insurer cannot deliver the future business that has been guaranteed. The concept of procurement risk is well-known in the art.

Therefore, as can be seen from the various embodiments of the present invention, claims fulfillment system 18 enables insurers 10 to trade their anticipated future claims fulfillment volume to suppliers 16 and consolidated networks.

Various embodiments of the present invention relate to processes being performed “automatically.” As indicated above, the term “automatically” indicates performance by a computer in an automated manner.

Moreover, the present invention is not limited to being implemented by a computer system. For example, all or part of the process described in FIG. 6 may be carried out manually with, for example, communication by telephone.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A process comprising:
aggregating claims fulfillment volume from multiple insurers for future periods; and
auctioning the aggregated claims fulfillment volume to suppliers.

2. A process as in claim 1, further comprising:
guaranteeing the auctioned aggregated claims fulfillment volume to the suppliers.

3. A process as in claim 1, further comprising:
load balancing actual claims fulfillment volume directed to suppliers winning the auctioned claims fulfillment volume.

4. A process as in claim 2, further comprising:
load balancing actual claims fulfillment volume directed to suppliers winning the auctioned claims fulfillment volume.

5. A process as in claim 1, further comprising:
presenting suppliers winning the auctioned claims fulfillment volume to a claimant submitting an actual claim; and
selecting a respective supplier of the presented suppliers by the claimant to fulfill the claim.

6. A process as in claim 1, wherein said auctioning comprises reverse auctioning the aggregated claims fulfillment volume to the suppliers.

7. A process as in claim 2, wherein said auctioning comprises reverse auctioning the aggregated claims fulfillment volume to the suppliers.

8. A process as in claim 3, wherein said auctioning comprises reverse auctioning the aggregated claims fulfillment volume to the suppliers.

9. A process as in claim 4, wherein said auctioning comprises reverse auctioning the aggregated claims fulfillment volume to the suppliers.

10. A process as in claim 5, wherein said auctioning comprises reverse auctioning the aggregated claims fulfillment volume to the suppliers.

11. An apparatus comprising:
an automated claims fulfillment system; and
computer communication channels connecting a plurality of insurers and a plurality of suppliers to the automated claims fulfillment system, the automated claims fulfillment system receiving an indication of claims fulfillment volume for future periods from the insurers through the computer communication channels, aggregating the claims fulfillment volume indicated by the insurers and auctioning the aggregated claims fulfillment volume to the suppliers through the computer communication channels.

12. An apparatus as in claim 11, wherein the automated claims fulfillment system provides guarantees of the auctioned aggregated claims fulfillment volume to the suppliers through the computer communication channels.

13. An apparatus as in claim 11, wherein the automated claims fulfillment system load balances actual claims fulfillment volume directed to suppliers winning the auctioned claims fulfillment volume.

14. An apparatus as in claim 12, wherein the automated claims fulfillment system load balances actual claims fulfillment volume directed to suppliers winning the auctioned claims fulfillment volume.

15. An apparatus as in claim 11, further comprising:
a claimant computer communication channel connecting a claimant submitting an actual claim to the automated claims fulfillment system, the automated claims fulfillment system presenting suppliers winning the auctioned claims fulfillment volume to the claimant through the claimant computer communication channel to allow the claimant to select a respective supplier of the presented suppliers through the claimant computer communication channel to fulfill the claim.

16. An apparatus as in claim 11, wherein the automated claims fulfillment system reverse auctions the claims fulfillment volume to the suppliers through the computer communication channels.

17. An apparatus as in claim 12, wherein the automated claims fulfillment system reverse auctions the claims fulfillment volume to the suppliers through the computer communication channels.

18. An apparatus as in claim 13, wherein the automated claims fulfillment system reverse auctions the claims fulfillment volume to the suppliers through the computer communication channels.

19. An apparatus as in claim 14, wherein the automated claims fulfillment system reverse auctions the claims fulfillment volume to the suppliers through the computer communication channels.

20. An apparatus as in claim 15, wherein the automated claims fulfillment system reverse auctions the claims fulfillment volume to the suppliers through the computer communication channels.

21. A computer-implemented process comprising:
automatically, by computer processing, aggregating claims fulfillment volume from multiple insurers for future periods; and
automatically, by computer processing, auctioning the aggregated claims fulfillment volume to suppliers.

22. A computer-implemented process as in claim 21, further comprising:
guaranteeing the auctioned aggregated claims fulfillment volume to the suppliers.

23. A computer-implemented process as in claim 21, further comprising:
automatically, by computer processing, load balancing actual claims fulfillment volume directed to suppliers winning the auctioned claims fulfillment volume.

24. A computer-implemented process as in claim 22, further comprising:
automatically, by computer processing, load balancing actual claims fulfillment volume directed to suppliers winning the auctioned claims fulfillment volume.

25. A computer-implemented process as in claim 21, further comprising:
automatically, by computer processing, presenting suppliers winning the auctioned claims fulfillment volume to claimants submitting actual claims; and
selecting, by computer processing, presented suppliers by the claimants to fulfill the claims.

26. A computer-implemented process as in claim 21, wherein said automatically auctioning comprises reverse auctioning the aggregated claims fulfillment volume to the suppliers.

27. A computer-implemented process as in claim 22, wherein said automatically auctioning comprises reverse auctioning the aggregated claims fulfillment volume to the suppliers.

28. A computer-implemented process as in claim 23, wherein said automatically auctioning comprises reverse auctioning the aggregated claims fulfillment volume to the suppliers.

29. A computer-implemented process as in claim 24, wherein said automatically auctioning comprises reverse auctioning the aggregated claims fulfillment volume to the suppliers.

30. A computer-implemented process as in claim 25, wherein said automatically auctioning comprises reverse auctioning the aggregated claims fulfillment volume to the suppliers.

31. An apparatus comprising:
means for aggregating claims fulfillment volume from multiple insurers for future periods; and
means for auctioning the aggregated claims fulfillment volume to suppliers.

32. An apparatus as in claim 31, further comprising:
means for presenting suppliers winning the auctioned claims fulfillment volume to a claimant submitting an actual claims; and
means for selecting by the claimant a respective supplier of the presented suppliers to fulfill the claim.

33. A process comprising:
aggregating claims fulfillment volume from a plurality of insurers;
estimating total claims fulfillment volume of the aggregated claims fulfillment volume to be guaranteed to suppliers;
auctioning the estimated total claims fulfillment volume to the suppliers; and
providing guarantees of the auctioned claims fulfillment volume to suppliers winning the reverse auctioned claims fulfillment volume.

34. A process as in claim 33, further comprising:
load balancing actual claims fulfillment volume directed to the winning suppliers.

35. A process as in claim 33, wherein said estimating estimates the total claims fulfillment volume in accordance with econometric and risk adjusted return models.

36. A process as in claim 33, further comprising:
presenting suppliers winning the auctioned claims fulfillment volume to a claimant submitting an actual claim; and
selecting a respective supplier of the presented suppliers by the claimant to fulfill the claim.

37. A process comprising:
committing claims fulfillment volume for future periods by a plurality of insurers;
aggregating the committed claims fulfillment volume from the plurality of insurers;
estimating total claims fulfillment volume of the aggregated, committed claims fulfillment volume to be guaranteed to suppliers;
auctioning the estimated total claims fulfillment volume to the suppliers; and
providing guarantees of the auctioned claims fulfillment volume to suppliers winning the auctioned claims fulfillment volume.

38. A process as in claim 37, further comprising:
load balancing actual claims fulfillment volume directed to the winning suppliers.

39. A process as in claim 37, wherein said estimating estimates the total claims fulfillment volume in accordance with econometric and risk adjusted return models.

40. A process as in claim 37, further comprising:
presenting suppliers winning the auctioned claims fulfillment volume to a claimant submitting an actual claim; and
selecting a respective supplier of the presented suppliers by the claimant to fulfill the claim.

41. A process comprising:
committing claims fulfillment volume for future periods by a plurality of insurers;
aggregating the committed claims fulfillment volume from the plurality of insurers;
estimating total claims fulfillment volume of the aggregated, committed claims fulfillment volume to be guaranteed to suppliers in accordance with econometric and risk adjusted return models;
reverse auctioning the estimated total claims fulfillment volume to the suppliers;
providing guarantees of the reverse auctioned claims fulfillment volume to suppliers winning the reverse auctioned claims fulfillment volume;
presenting the winning suppliers to claimants submitting actual claims;
selecting presented suppliers by the claimants to fulfill the claims; and
load balancing actual claims fulfillment volume directed to the winning suppliers.

42. A computer-implemented process comprising:
committing claims fulfillment volume for future periods by a plurality of insurers;
automatically, by a computer, aggregating the committed claims fulfillment volume from the plurality of insurers;
automatically, by a computer, estimating total claims fulfillment volume of the aggregated, committed claims fulfillment volume to be guaranteed to suppliers;
auctioning, by a computer, the estimated total claims fulfillment volume to the suppliers; and
providing guarantees of the auctioned claims fulfillment volume to suppliers winning the auctioned claims fulfillment volume.

43. A computer-implemented process comprising:
committing claims fulfillment volume for future periods by a plurality of insurers;
aggregating, by a computer, the committed claims fulfillment volume from the plurality of insurers;
estimating, by a computer, total claims fulfillment volume of the aggregated, committed claims fulfillment volume to be guaranteed to suppliers in accordance with econometric and risk adjusted return models;
reverse auctioning, by a computer, the estimated total claims fulfillment volume to the suppliers;
providing guarantees of the reverse auctioned claims fulfillment volume to suppliers winning the reverse auctioned claims fulfillment volume; and
load balancing, by a computer, actual claims fulfillment volume directed to the winning suppliers.

44. An apparatus comprising:
means for committing claims fulfillment volume for future periods by a plurality of insurers;
means for aggregating the committed claims fulfillment volume from the plurality of insurers;
means for estimating total claims fulfillment volume of the aggregated, committed claims fulfillment volume to be guaranteed to suppliers;
means for auctioning the estimated total claims fulfillment volume to the suppliers; and
means for providing guarantees of the auctioned claims fulfillment volume to suppliers winning the auctioned claims fulfillment volume.
